(19) United States
(12) Patent Application Publication
(10) Pub. No.: US 2017/0193579 A1
(43) Pub. Date: Jul. 6, 2017

(54) SYSTEM AND METHOD TO CALCULATE SESSION-BASED PRICE DEMAND ON E-COMMERCE SITE

(71) Applicant: eBay Inc., San Jose, CA (US)

(72) Inventors: David Goldberg, Palo Alto, CA (US); Yuanjie Liu, Shanghai (CN); Xiaoyuan Wu, Shanghai (CN); Nadia Vase, Los Altos, CA (US)

(73) Assignee: eBay Inc., San Jose, CA (US)

(21) Appl. No.: 14/986,203

(22) Filed: Dec. 31, 2015

(51) Int. Cl. G06Q 30/06; G06Q 30/02

(52) U.S. Cl. CPC G06Q 30/0625; G06Q 30/0201

(57) ABSTRACT

In various example embodiments, a system and method for computing price demand of a query that can be used by a search system to rank search results. Computing a user event aggregation by contribution for each of the past user sessions to produce updated session-based sets of user events based on a condition related to a general-specific relationship between two queries in a past user session. Computing a user event aggregation of queries from multiple sessions to combine the updated session-based sets of user events for a same query from the past user sessions to produce multiple session sets of user events for each query. The multiple session sets of user events for a query defining price points used in determining price demand for the query.

### TECHNICAL FIELD

Embodiments of the present disclosure relate generally to data processing and, more particularly, but not by way of limitation, to computing session-based price demand for a search query.

### BACKGROUND

Searching e-commerce sites, as well as other searching performed on the Internet, is often performed by receiving queries from users. A query refers to a request for information from a database. In various embodiments, the query parameters, also referred to as search terms, are provided by the user by typing in one or more search terms. In some embodiments, the query parameters may be chosen from a menu.

The relevance of e-commerce searching can directly and measurable impacts sales. For example, presenting items to a user that are most relevant to that user is more likely to lead to a sale of an item by that user. Locating the most relevant items for purchase is generally done by searching the database. Many factors are used to rank search results for a user. For example, price demand is one factor that is used by search engines to generate search results.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 illustrates a block diagram of an information storage and retrieval platform, including a runtime system and an offline system, in accordance with an example embodiment.

FIG. 3 illustrates a block diagram of the dictionary information shown in FIG. 1D with multiple dictionaries, in accordance with an example embodiment.

FIG. 4 illustrates a detailed block diagram of the search servers and the query node servers shown in FIG. 2 in further detail, in accordance with example embodiments.

FIG. 5 illustrates a block diagram of low level aggregators (LLA) querying a grid of item query nodes, in accordance with an example embodiment.

FIG. 6 illustrates indexing a list of documents to an item in an item QN, in accordance with an example embodiment.

FIG. 7 is a block diagram of a search system for processing queries, in accordance with an example embodiment.

FIG. 8 illustrates a block diagram the item ranking modules shown in FIG. 7 in further detail, in accordance with example embodiments.

FIGS. 9A-C illustrate a user interface of a search system used to receive search queries from a user, in accordance with an example embodiment.

FIG. 9D illustrates a table that summarizes a session with three search queries illustrating an example user event aggregation by contribution for a single session, in accordance with an example embodiment.

FIG. 9E illustrates a table illustrating relationships between two queries in a session and relevant contributions, in accordance with an example embodiment.

FIGS. 10A-E shows tables used to illustrate an example of user event aggregation of queries from multiple sessions, in accordance with an example embodiment.

FIG. 10F illustrates an example price demand table, in accordance with an example embodiment,

FIG. 11 illustrates price demand chart, in accordance with an example embodiment.

FIG. 12 is a flow diagram 1200 illustrating an example method of generating price points for computing price demand for a query, in accordance with example embodiments.

FIG. 13 is a flow diagram 1300 illustrating an example method of generating price demand for a query based on view events and buy events, in accordance with an example embodiment.

FIG. 14 is a flow diagram 1400 illustrating an example method of computing price demand in further detail, in accordance with an example embodiment.

FIG. 15 is a block diagram illustrating an example of a software architecture that may be installed on a machine, according to some example embodiments.

FIG. 16 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In example embodiments, a number of features are used by a search system to generate results for a search query. The search system searches one or more databases for items matching the query and then returns various items to be presented to a user. The items are presented in a ranked order based on predictions made by the search system as to the most relevant results for users. The search system uses a number of features to determine the relevancy of items from a database of items. For example, the database of items may represent an inventory database in an e-commerce system in some example embodiments. In other embodiments, the search system is not limited to an e-commerce system, and may be used for other types of searching.

In various embodiments, features are related to items and may be used to describe items. For example, a feature may represent an item title, an item price, a name of a seller of an item, other seller information, category of an item, and computed values (e.g., demand for a price by buyers and demand for a category). Each of the features can be represented quantitatively by the search system. By defining a set of features for items, each of the items may be represented quantitatively by taking into account the various features used by the system to rank items returned from a query. For example embodiments, this quantitative measure can be referred to as a ranking score, and is used to compare a number of items to measure relevancy of an item for a given search query. The ranking score impacts the order in which search results are presented to a user.

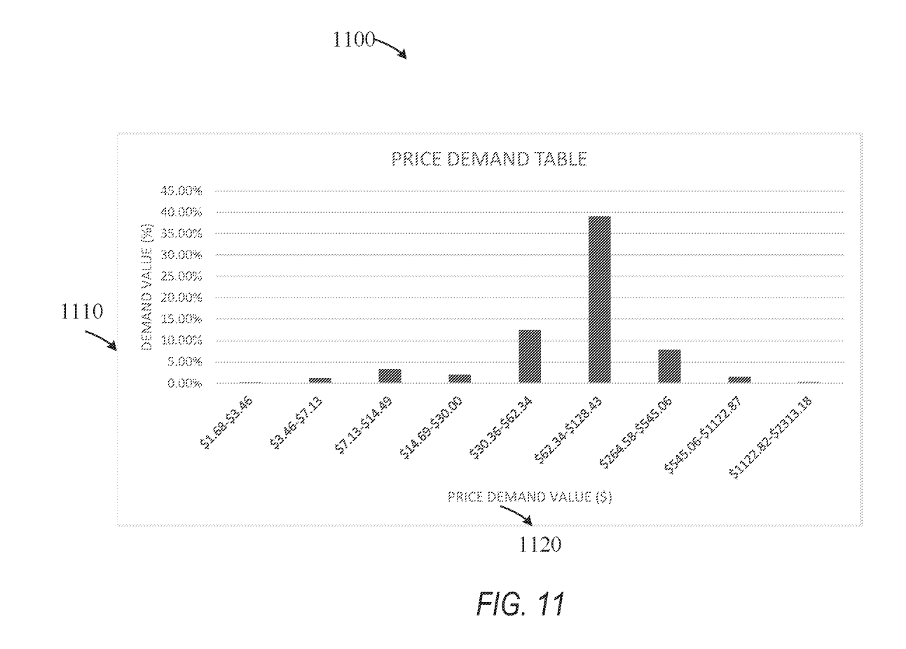

One way to improve the ranking score is to select features that are most useful in measuring relevancy or importance of a returned item relative to other returned items. It has been observed that price demand is a useful feature in ranking returned items to enable a search system to predict the most relevant items from the search results for a query. Historical pricing information (of past users) can be a good indicator of a price range a buyer is most likely to spend (or is interested in spending) on an item when submitting a particular search query. For example, one observation is that buyers, on the average, buy at a typical price. Returned items that are very expensive (i.e., on the high end of the price distribution from the historical query data) are usually purchased by buyers who are interested in certain specialized features of an item. Returned items that are very inexpensive (i.e., on the low end of the price distribution from the historical query data) often represent accessories for the item and not the actual item itself. The price demand for a query, which may be represented as a price distribution with demand values associated with price ranges, (an example of which is shown in FIG. 11) provides a good indicator that a user is likely to buy an item within a certain price range when submitting a search query.

In various embodiments, a session includes multiple queries provided by a user. In some embodiments, a session on an e-commerce site may lead to a sale of an item. In other embodiments a session on an e-commerce site may not lead to any sale, but may include generating search result pages and viewing (e.g., via clicking) one or more items presented on the search results pages.

A session can be initiated when a user logs into a site, or is recognized by the site as returning user who is associated with activity on the site. For example, a site may recognize a returning user via cookies. A session can be considered terminated after a user logs off of a site or becomes inactive (or idle) on the site for a predetermined period of time. For example, after 30 minutes of idle time without user input (i.e., not receiving any queries or clicks), the system may automatically end a session.

During a session on an e-commerce site, a user may be shopping for a particular type of item for purchase. Furthermore, during a session, multiple queries may be related. For various embodiments, a related query refers to a query which includes the base search term(s) from an initial query and one or more additional search terms. The additional search term may be used to limit or refine the initial query Q1. For example, an initial query (Q1) includes the search term “lego.” A related query, referred to as Q2 (lego Star Wars), includes the search term “lego” and the additional search term “Star Wars.” In response to each query, search results are generated for display to user. Another query, referred to as Q3, includes the search terms “girl's toys” and is not related to either Q1 or Q2.

In various embodiments, the latter queries contribute to earlier queries if a latter query contains an entire search string of a former query. The search string may contain one or more words. In some embodiments, the search string may contain words that have been modified via a query expansion algorithm, for example making adjustments to variations of similar terms having a same stem (e.g., singular and plural variations, lower case and upper case variations). In this situation, the latter query is considered to be a more specific query of the earlier query, to some extent. Such a contribution may be considered reasonable when two queries from a session have some “general-specific” relationship. The contribution from the latter query to the earlier query (when a general-specific relationship exists) can include combining the set of user events from the latter query with the set of user events with the former query. The set of events associated with the former query increases as user events from latter queries are added or contributed to it. This session-based contributions from former queries may increase the relevant data used to compute price demand for the former query by adding additional price points. As more price points are associated with a query, the price distribution (representing buyer demand by price range), provides more insight as to what buyers are likely to purchase such that a search system can present more relevant search results.

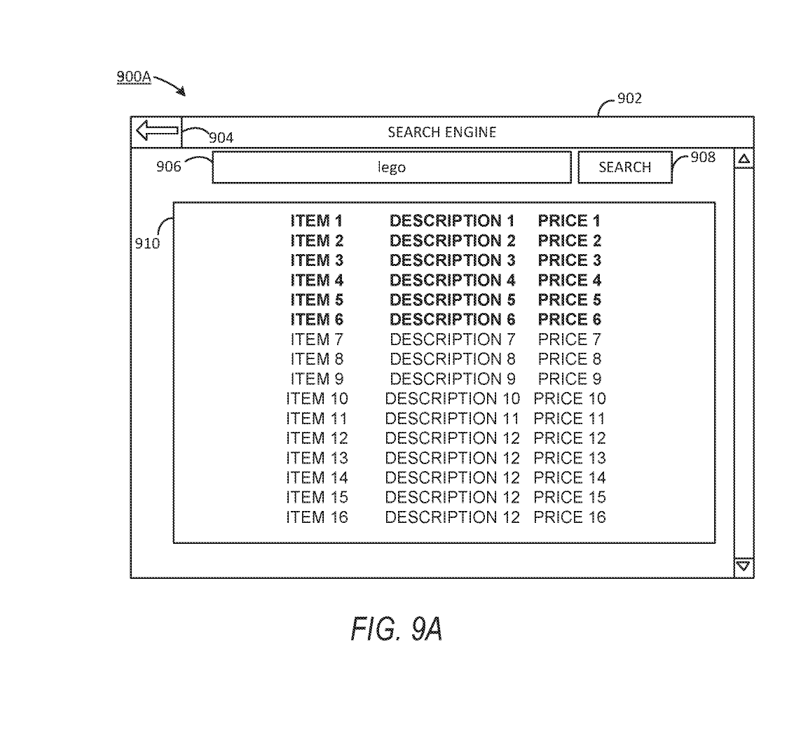

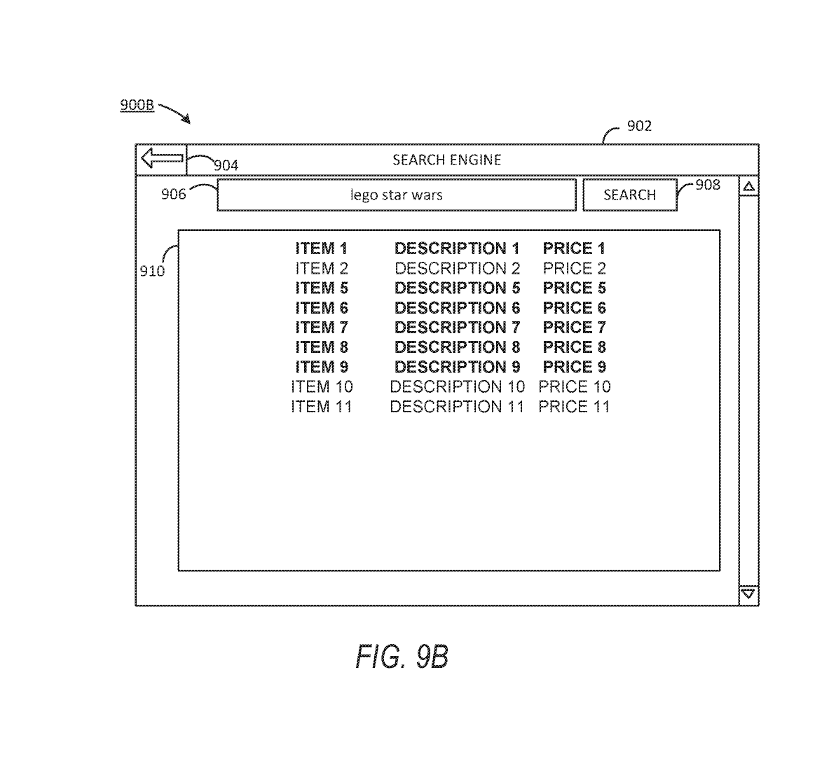

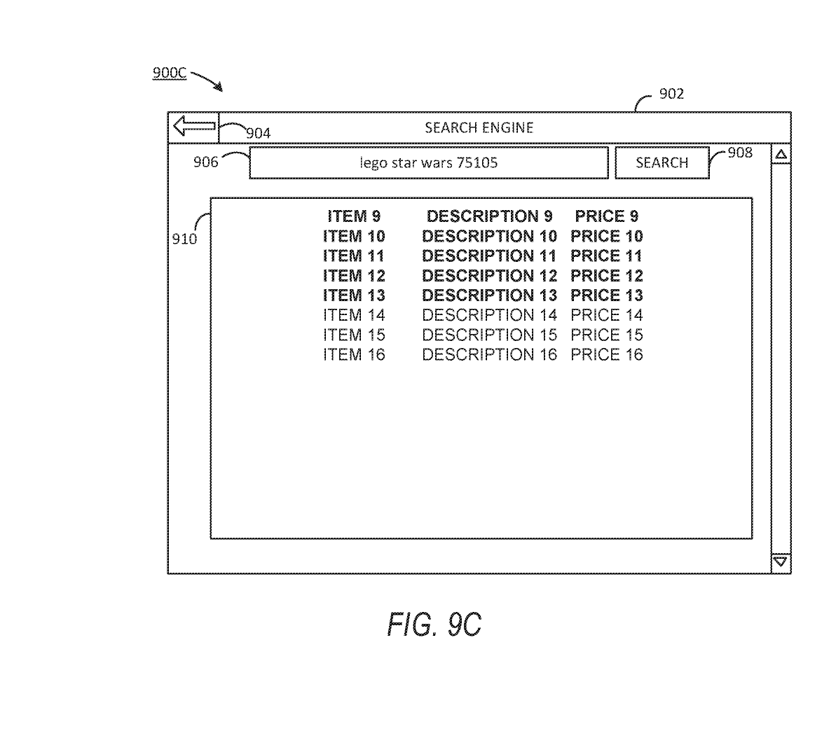

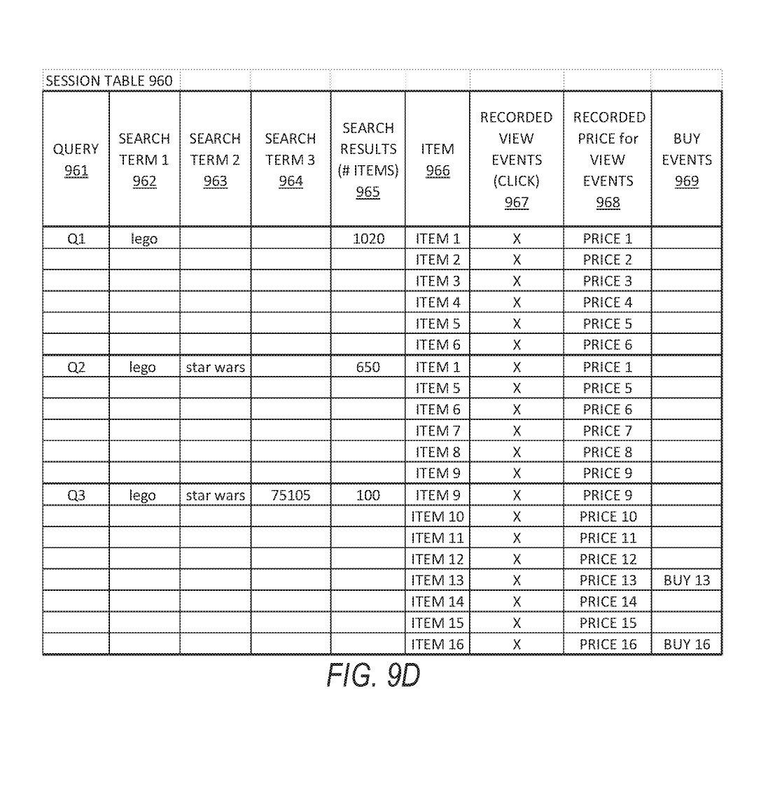

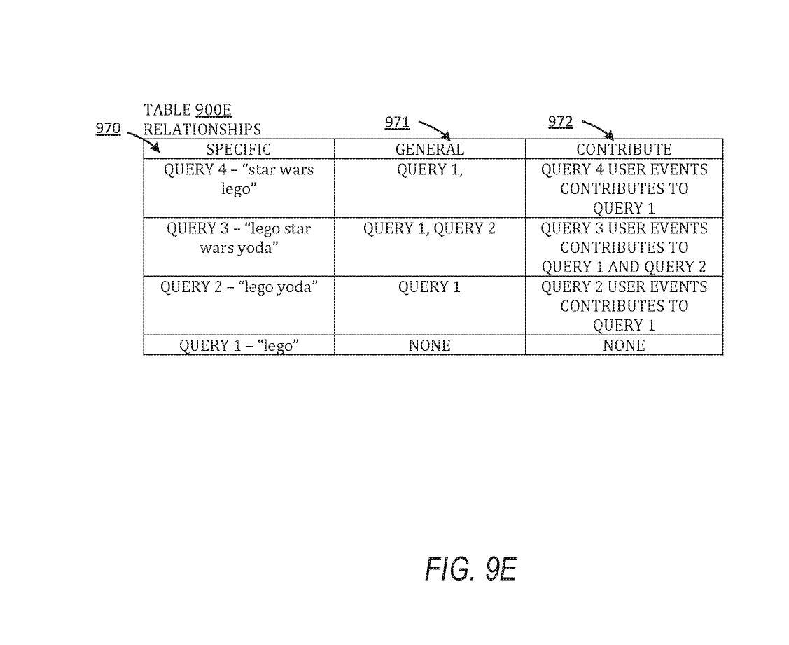

According to various embodiments, the user events (and associated prices) are aggregated twice. The first type of aggregation is referred to as user event aggregation by contribution (or contribution aggregation of user events per session) and is based on contributions of latter queries if a specific condition is met for queries within a session. An example of the user event aggregation by contribution is described in FIGS. 9A-9D. The aggregation by contribution for a single session produces session-based sets. The sets may refer to sets of user event, sets of prices, and sets of user event-price pairs. Thus, the aggregation by contribution produces session-based sets of user events, session-based sets of prices, and session-based sets of user-event pairs.

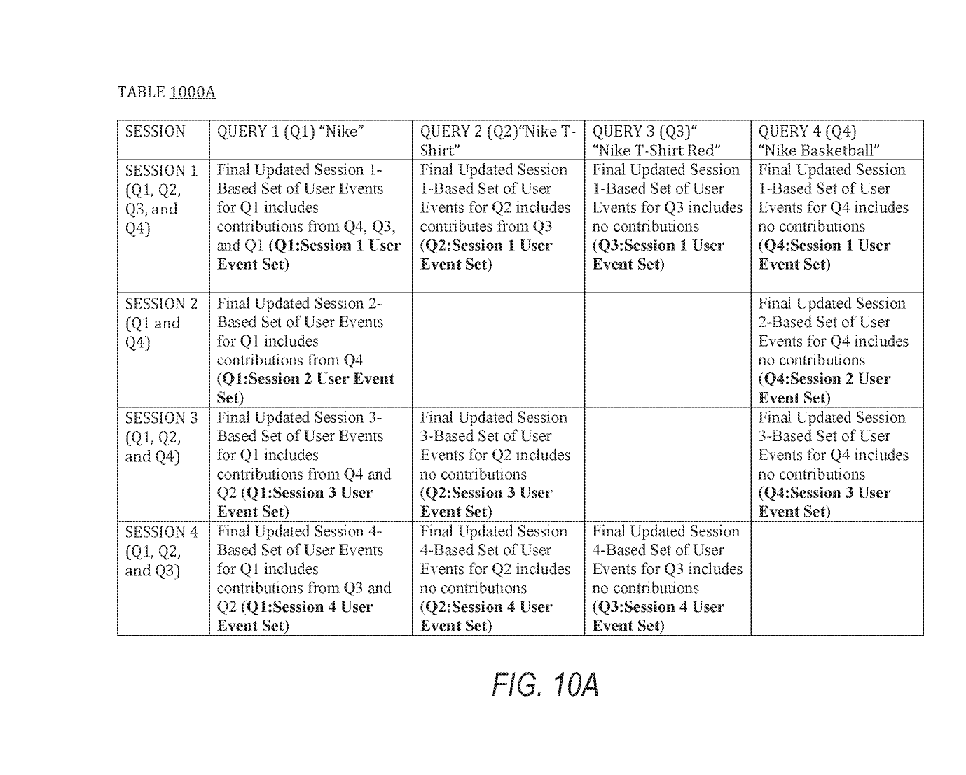

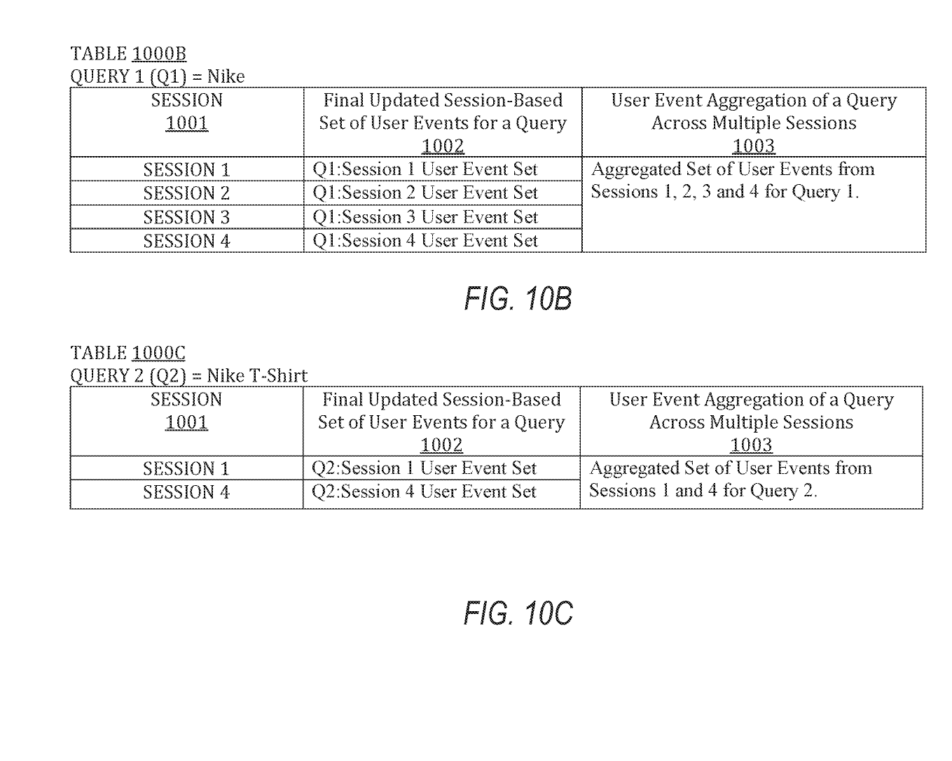

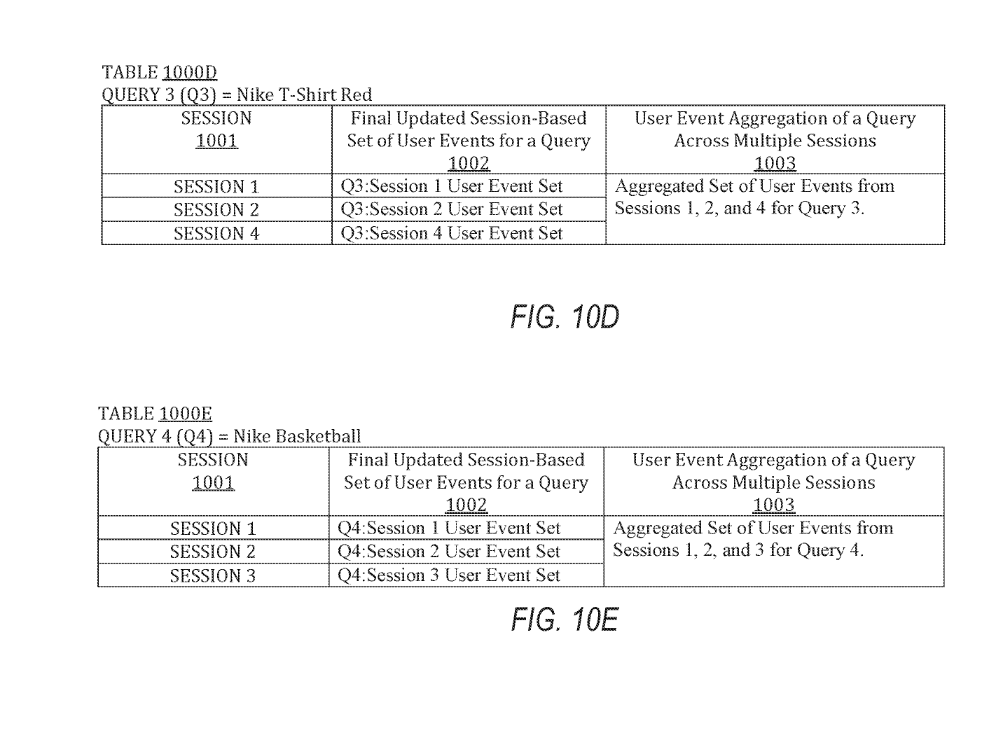

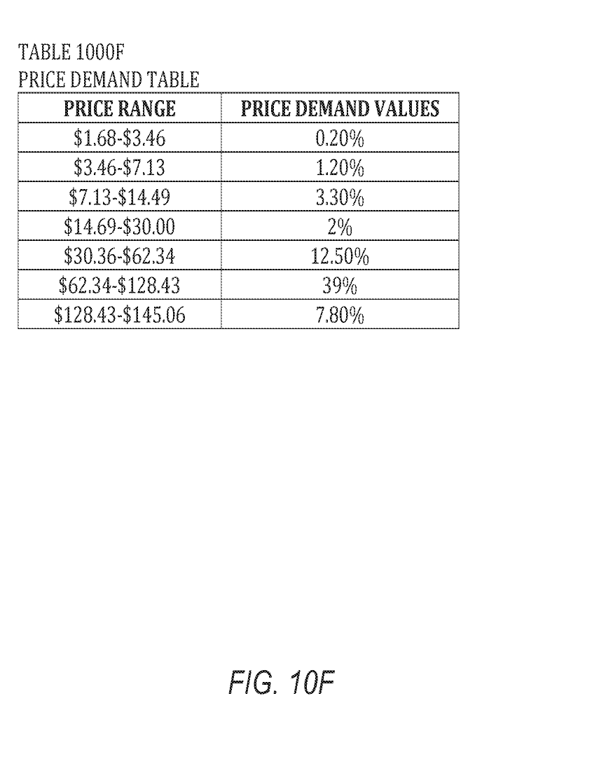

The second type of aggregation, which occurs after the user event aggregation by contribution for a single session, is referred to as user event aggregation over sessions (or multiple session user event aggregation). An example of the second type of user event aggregation is described in FIGS. 10A-10H. The user event aggregation of queries from multiple session produces multiple session sets. The multiple session sets may refer to sets of user events, sets of prices, and sets of user event-price pairs. Thus, the user event aggregation of multiple sessions produces multiple session sets of user events, multiple session sets of prices, and multiple session-sets of user-event pairs.

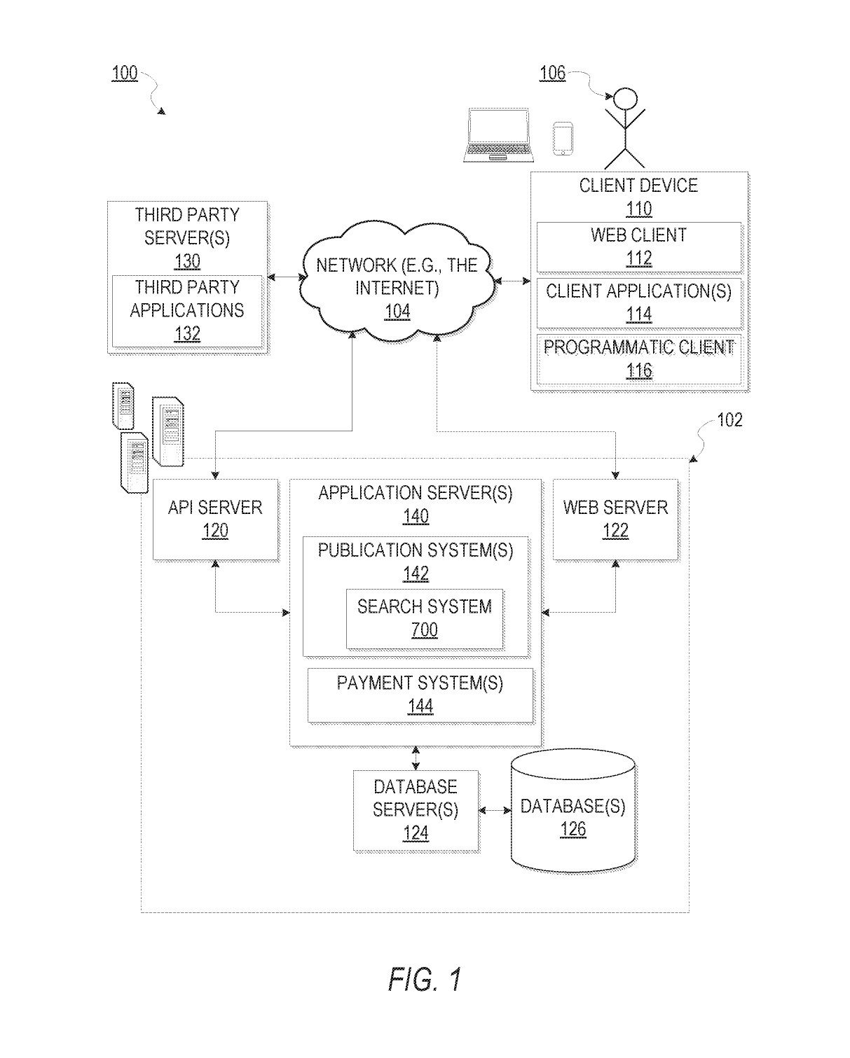

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash.), one or more application(s) 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth.

The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions.

One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e,g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110. In various embodiments, a user 106 may interact with a client application 114, such as a marketplace application, by submitting queries to search for items available on the marketplace application. The user 106 may further interact with the marketplace application, for example, by viewing items presented on the search results page (also referred to as impressions), clicking on items presented on the search results page to view the item details (also referred to as viewing), selecting items to be placed in a shopping cart, and purchasing items placed in the shopping cart.

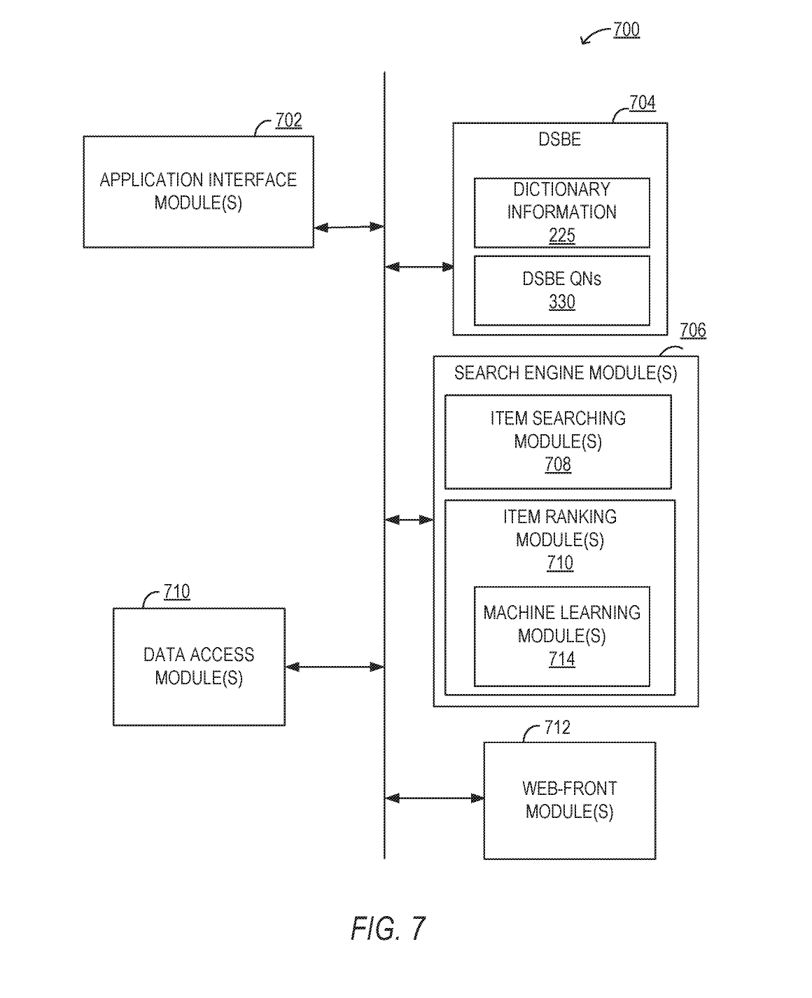

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. In example embodiments, the publication system 142 may represents an e-commerce site. In various embodiments, the publication system 142 includes a search system 700 for receiving search queries and producing search results. An example of a search system is shown in FIG. 7. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital item information in accordance with example embodiments.

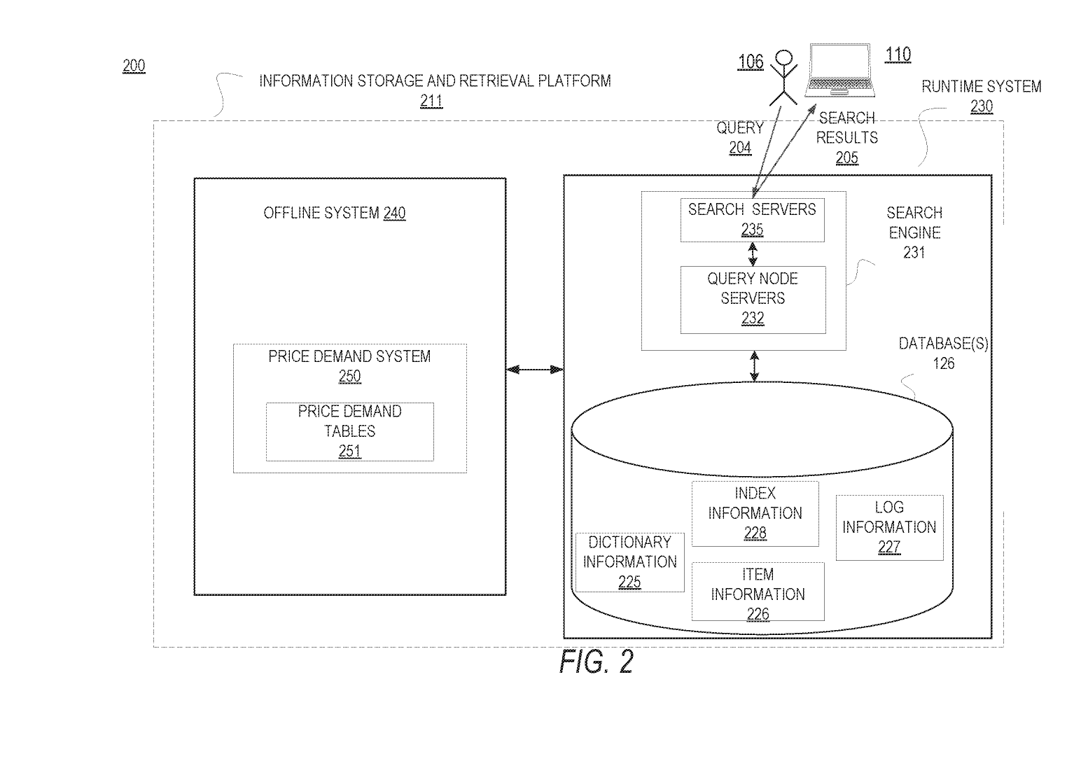

In example embodiments, the databases 126 may include one or more databases that store item information such as listings indexed by categories, index information used to index the item listings, log information such a log of user behavioral data (including search queries from past users and associated user interactions related to the search queries), and dictionary information that stores price demand information. FIG. 2 illustrates the dictionary information 225 item information 226, log information 227, and index information 228 within one or more databases 126 stored within one or more databases 126.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. For example, the publication systems 142 may provide an e-commerce site that users 106 may shop on. The users may access this e-commerce site via a client application 114, such as a marketplace application. While shopping online via a marketplace application, users 106 can submit search queries and review the search results provided by the publication system 142. The search results provides a listing of items in a ranked order. The session-based price demand (based on view item counts or other interactions with the user) is one factor used by ranking algorithms to rank the item listings in the search results presented to the user 106 on the client device 110.

The payment systems 144 may likewise provide a number of functions to perform or facilitate payments and transactions. For example, the payment systems 144 may allow users 106 to purchase items from an e-commerce site. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and personalization system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

FIG. 2 illustrates a system 200 for an information storage and retrieval platform 211 that utilizes a search infrastructure, according to an example embodiment. The information storage and retrieval platform 211 is communicatively coupled over a network (e.g., Internet) (not shown) to the client machine 100 associated with the user 106. The information storage and retrieval platform 211 includes a runtime system 230 and an offline system 240. The runtime system 230 may represent an e-commerce site or an online search system.

In various embodiments, the information storage and retrieval platform 211 provides a system for computing e-commerce price demand for search queries. The price demand may be used as input into one or more ranking algorithms for ranking items returned by a search engine. One or more components of the information storage and retrieval platform 211 may be included within the publication system 142, shown in FIG. 1. The various components within the information storage and retrieval platform 211 may be communicatively coupled with any combination of a wide area network, local area network, wireless network, or any other type of network utilizing various networking technologies.

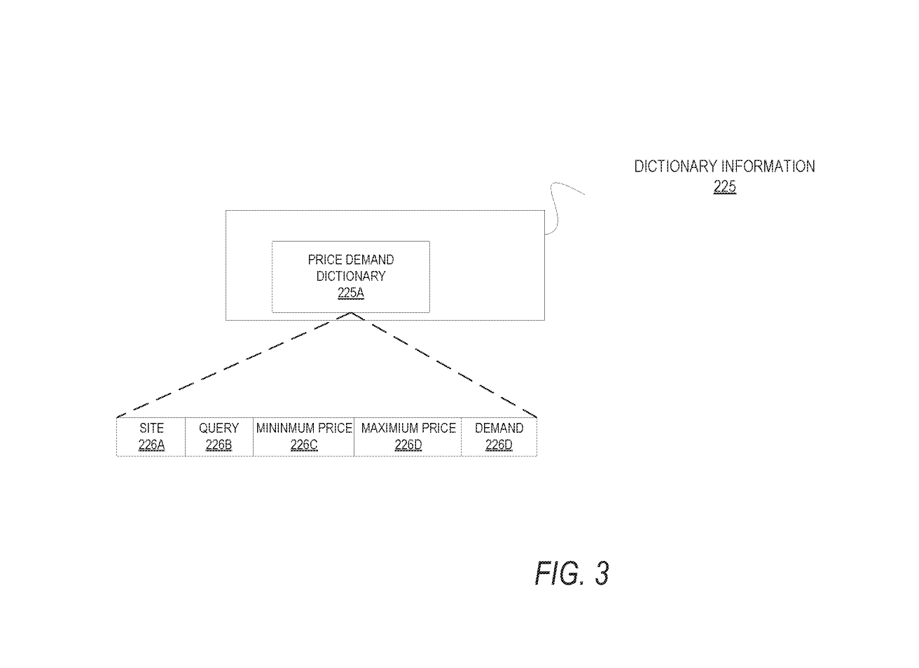

In example embodiments, the runtime system 230 includes the searchable portion of the publication system 142 and may be referred to as a backend system. The runtime system 230 includes search servers 235, query node servers 232, and one or more databases 126. In an example embodiment, the search servers 235 and the query node servers 232 are included within a search engine 231. The backend system is also described in FIG. 3.

Some of the information stored in the databases 126 are accessed by the offline system 240 to generate one or more dictionaries offline. For example log information 227, which includes search information (also referred to as historical query data) from prior queries and various user interactions associated with those queries, is accessed by the offline system 240. A price demand system 250 generates the price demand tables 251 in example embodiments. The log information 227 may be accessed periodically and used to update the price demand tables 251. A copy of the price demand table 251, or updates to the price demand tables 251, which are computed offline, are transferred to the runtime system 230 and stored in the databases 126 as dictionary information 225 in example embodiments. The dictionary information 225 is accessible to the runtime system 230 when a user 106 submits a query.

The dictionary information 225 includes one or more dictionaries that may be used as lookup tables. FIG. 3 illustrates the dictionary information 225 in further detail. The dictionary information 225 shown in FIG. 3 includes the price demand dictionary 225A. In other embodiments, the dictionary information 225 may include other dictionaries as well. In various embodiments, the dictionary information, along with demand service back end (DSBE) query nodes form a DSBE that is used fetch data on demand during runtime. The DSBE will be described in conjunction with FIG. 7 in further detail.

The offline system 240 shown in FIG. 2 includes the price demand system 250, which computes price demand tables 251. The generation of the price demand tables 251 is performed offline. In example embodiments, the price demand 251 represent a text file with rows, and each row contains (site ID, query, minimum price, and maximum price, demand score). The process of computing the price demand tables 251 may be automated on a regular basis (e.g., weekly) to ensure the data stays fresh. The text file generated is then copied and loaded into the databases 126 as dictionary information 225. For an example embodiment, the price tables 251 are stored as dictionary information 225 in the databases 126 in the runtime system 230, and may referred to as the price demand dictionary. The price demand dictionary will be discussed further in conjunction with FIG. 3 below. The dictionary information 225 is accessible by the runtime system 230 when a query is received.

The demand for price of a given search is based on historical data, for example, what past users searched and what items they viewed by clicking on the item. For a given query, the price associated with the viewed items, or other interactions with the users (e.g., impressions which refers to viewing search results without clicking) from historical query data, may be used to determine the price demand for that given query.

The information stored in the databases 126 in the runtime system 230, which is accessed by the query node servers 232, is stored in a format that can be consumed by the query node servers 232. For example the dictionary information 225 and the index information 228 are accessed by the query node servers 232 during runtime and are stored in a format that can be consumed by the query node servers 232. During runtime, the runtime system 230 performs two separate and independent processes. One process is to determine the price demand and the second process is to return the matched items. The price demand score is used by the search engine modules 231 to rank the matched items from the search query.

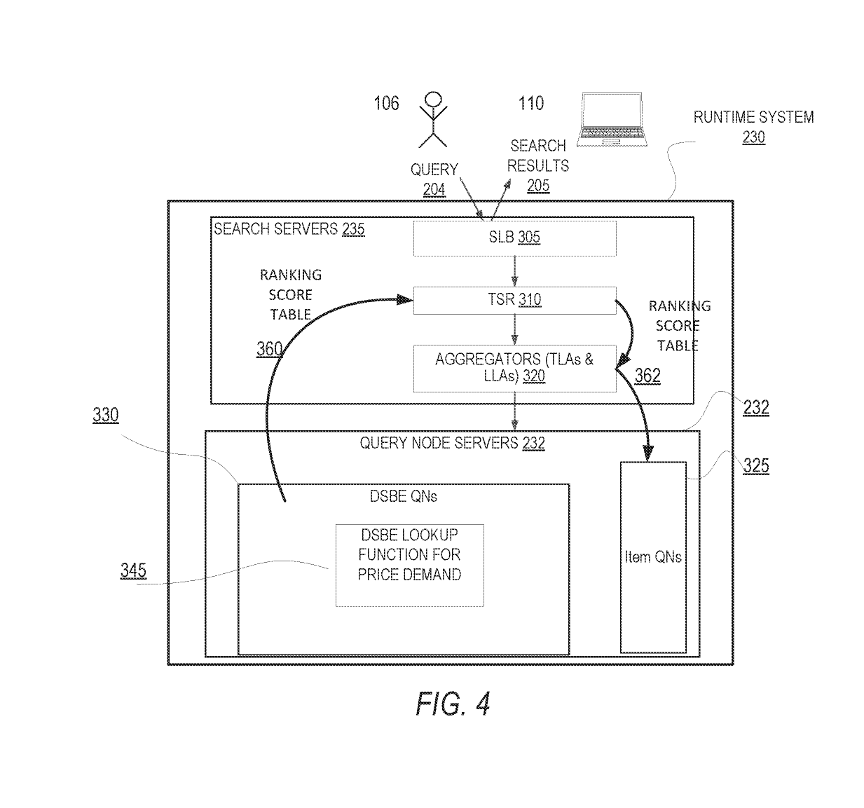

The search servers 235 may include search front-end servers that executes on search machines (not shown) and search back-end servers that execute on search machines (not shown) communicatively coupled together. In example embodiments, the query node servers 232 include two types of QNs, the item QNs and the DSBE QNs. The item QNs are queried to find the matched items for a query. The DSBE QNs includes nodes to retrieve the price demand scores for queries, which were computed offline in example embodiments. The two types of QNs will be discussed in further detail along with FIG. 4.

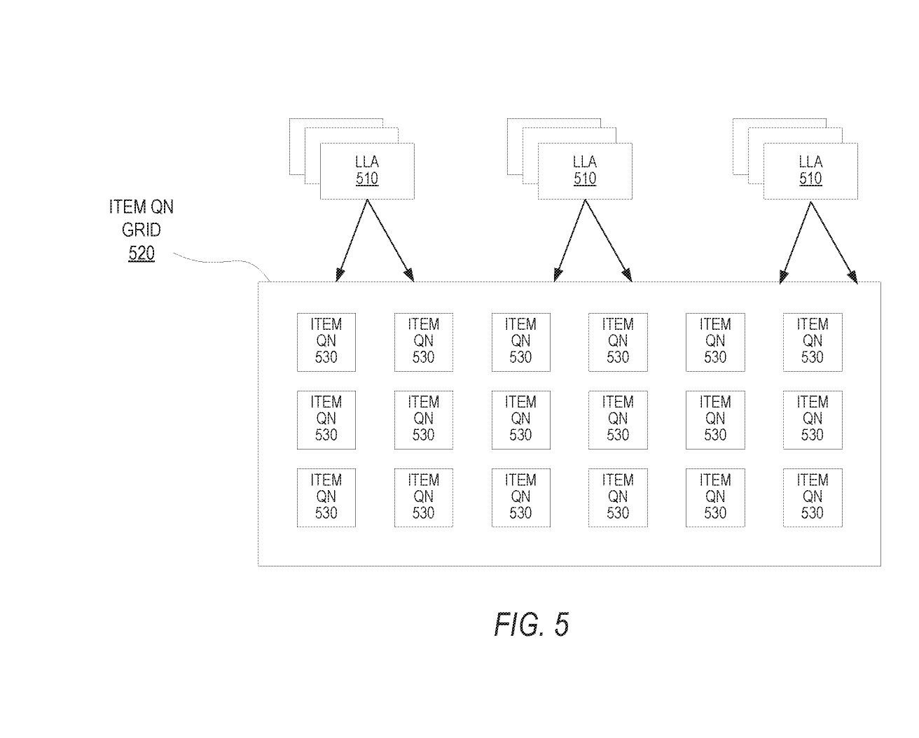

The index information 228 may be stored in memory of the query node servers 232 and/or in the database 126 connected to the query node servers 232. The index information 228 may be used to perform index lookup in the item QNs. In some embodiments, the item QNs within the query node servers 232 receives a copy of what is published by the publication system 142. For example, index information 228 (e.g., updated documents or actual data, and inverted index data) gets copied into every single item QN in query node servers 232. The query node servers 232 may be comprised of a search grid of item QNs that is arranged in columns of QNs. Each column of query node servers 232 may be utilized to manage a range of the documents. An example of a search grid of item QNs is shown in FIG. 5.

The user 106 who operates the client device 110 may enter a query 204 that may be communicated over a network (e.g., Internet) via search servers 235 to be received by the query node servers 232 which may be divided into two layers in an example embodiment. The two layers may include an aggregation layer and a query execution layer. The aggregation layer may include a query node server 232 that includes a query engine (not shown) that receives the query 204 that, in turn, communicates the query to multiple query engines that respectively execute in the execution layer in multiple query node servers 232 that correspond to the columns. The aggregation layer may include a top level aggregator (TLA) and low level aggregators (LLA). The query engines in the query execution layer may, in turn, respectively apply the same query, in parallel, against respective indexes from the index information 228 that were generated for a range of document identifiers (e.g., column) to identify search results (e.g., document) in parallel. Finally, the query engines, at each query node server 232 in the query execution layer, may communicate their respective partial search results 205 to the query engine in the aggregation layer which aggregates the multiple sets of partial search results to form a search result 205 for the entire index information 228 and to communicate the search result 205 over the network to the user 106 by presenting the search results 205 on the client device 110.

FIG. 3 illustrates the dictionary information 225 in further detail, according to an example embodiment. The dictionary information 225 may be stored in one or more databases 126 (as shown in FIG. 2) and include a price demand dictionary 225A. The price demand dictionary may include the information in a lookup table that includes columns for site 226A, query 226B, minimum price 226C, maximum price 226D, and demand 226D. The demand represents a demand score. During runtime, the price demand dictionary 225A may be used as a lookup table when a query is received to lookup the price demand associated with the query. The price demand, and other statistical information generated from past queries, may also be used by a search engine to produce search results in a ranked order.

FIG. 4 illustrates the search servers 235 and the query node servers 232 in further detail. The architecture shown in FIG.4 may be referred to as the query serving stack (QSS) architecture and represents many of the components in the runtime system 230. The QSS architecture is responsible for taking a query and the returning matching items in a ranked order,

The search severs 235 receive a query during runtime. The QSS architecture distributes the computations across the various item nodes 325 when processing a search query. The search servers 235 include a software load balancer (SLB) 305, a transformer (TSR) 310, and aggregators 320, which includes top level aggregators (TLA) and low level aggregators (LLA).

The computation of the dictionaries, which is performed offline (i.e., by computing the price demand tables 251), operates independently of this QSS architecture. The computation of the price demand dictionary involves the computation of a large text file offline with rows. Each row contains a site identifier (ID), query, minimum price, maximum price, and demand score. In an example embodiment, an automatic process generates the text file every week so that the data in the price demand dictionary stays fresh. The data used to compute the price demand dictionary (using the price demand tables) is based on historical user query data.

Data from the price demand table 251 which was computed offline is then copied and loaded into the price demand dictionary 225A and used by the DSBE QNs 330. For various embodiments, the DSBE QNs 330, given a query, returns matching records. The index of the DSBE QNs 330 typically maps the queries to tuples of data, for example, tuples of (price, demand score) for the query. The DSBE lookup function for price demand 345 produces the price demand scores and transfers the demand scores in a ranking score table to the item QNs 325 via the TSR 310. The ranking score table includes the tuples of (price, price demand) for a query. The TSR 310 then transfers the ranking score table to the aggregators 320 for distribution to the item QNs 325.

The SLB 305 provides software load balancing functionality to distribute the load across the various item QNs 325. For example, the SLB 305 determines which item QNs have the least load and then determines how to distribute the search process across the different item QNs 325. As mentioned above, all information distributed to the item QNs 325 is copied into each item QN. In one example, the item QNs 325 may be implemented using the item QN grid 420 with item QNs 430 arranged in columns and rows as shown in FIG. 4. The same information is distributed to each item QN 430.

Information from the SLB 305 is passed down to the TSR 310. The TSR 310 provides functionality to better understand the query and to transform the query into more complex objects. The TSR 310 is also responsible for providing decision making functionality regarding what DSBE calls that need to be made to the DSBE QNs 330. In certain situations, rather than performing computations by the individual item QNs, the TSR 310 may offload some of that functionality by providing the information to the item QNs 325 after the computations are performed, such that individual item QNs 325 do not have to perform that computations individually.

In example embodiments, the TSR 310 has direct communications path to the DSBE QNs such that the TSR 310 may make DSBE calls to the DSBE QNs 330 to retrieve the demand scores found by the DSBE lookup function by price demand 345. The ranking score table is transferred directly from the DSBE QNs 330 over path 360 to the TSR 310.

In various embodiments, the ranking score table is transferred from the DSBE QNs 330 to the item QNs 325 via the TSR 310 using a DSBE usecase query. This table is used in a regular fashion to compute price demand during runtime when queries are received.

FIG. 5 illustrates an example of an item QN grid 520. As shown in FIG. 5, the item QN grid 520 includes a number of item QNs 530 arranged in rows and columns. The low level aggregators 510 (LLA) and the item QNs 530 locate the matching items using an index. The index lookup is done in parallel in the item QNs 530. In example embodiments, the item QNs 530 also rank the matched items. The price demand scores computed by the DSBE QNs are provided to the item QNs for input into the ranking algorithms used to rank the matched items. The transfer of the price demand data from the DSBE QNs to the item QNs were discussed above in conjunction with FIG. 4.

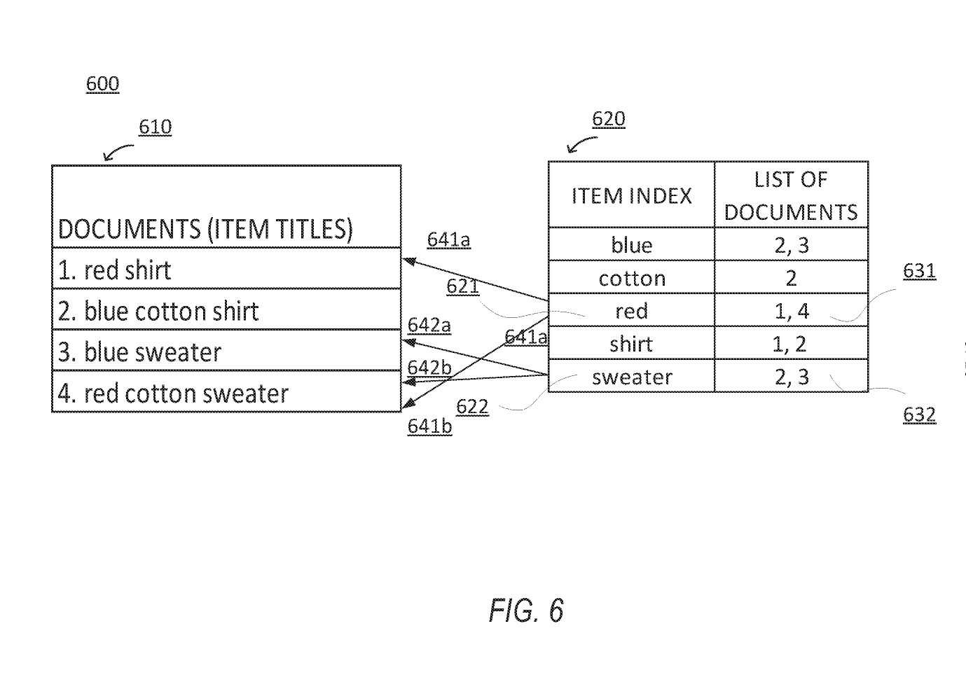

Referring now to FIG. 6, an example 600 of using an index in an item QN is shown. For the example shown in FIG. 6, a query “red sweater” is received. A list of documents 610 is referred to be item titles. There are four documents shown in the list 610. A list of item indexes 620 is also shown. Each word in the list of item indexes 620 is associated with a list of documents. For the query “red sweater” there are two words red 621 and sweater 622 that are associated with a list of documents. A list 631 is associated with the word red 621. A list 632 is associated with the word sweater. The list 631 includes the documents red shirt and red cotton sweater. The list 632 includes the documents blue sweater and red cotton sweater. In this example, the red cotton sweater appears on both lists 631 and 632 such that the query “red sweater” returns item 4 which is the red cotton sweater.

As mentioned above, the item QNs compute a ranking of the search results. The item QNs receive a query as input and produces a set of items matching the query. An index is used to find items by mapping words to documents. Items are matched using the words of the query. Referring to FIG. 6, the arrow 641a maps the word red 621 to item 1 (red shirt) and the arrow 641b to item 4 (red cotton sweater). Also shown in FIG. 6, the arrow 642a maps the word sweater 622 to the item 3 (blue sweater) and the arrow 642b maps the word sweater 622 to item 4 (red cotton sweater). In this example, the set of items matching the query only includes one item, item 4 (red cotton sweater). For each returned item, the item QN then computes a ranking score. In various embodiments, the higher the ranking score, the better the match between the items (e.g., documents) and the query (based on the words of the query). In example embodiments, the items are ranked by score and the item QNs return the set of items, together with their ranking score.

FIG. 7 is a block diagram illustrating an example embodiment of a search system 700 including multiple modules forming at least a portion of the runtime system 230 of FIG. 2 and FIG. 4. In some embodiments, the components of the search system 700 can be included in the publications system 142 of FIG. 1. However, it will be appreciated that in alternative embodiments, one or more components of the search system 700 described below can be included, additionally or alternatively, in other devices, such as one or more of the payment systems 144.

The modules 702-714 of the illustrated search system 700 include an application interface module(s) 702, DSBE tnodule(s) 704, a search engine module(s) 706, a data access module(s) 710, and a web-front module(s) 712. The application interface module(s) 702 includes a user-facing sub-module(s) 714, an application-facing sub-module(s) 716, and a third party-facing sub-module(s) 718. The search engine module(s) 706 includes an item searching module(s) 708, an item ranking module(s) 710, which includes a machine learning module(s) 714.

The modules 702-714 of the search system 700 can be hosted on dedicated or shared server machines (not shown) that are communicatively coupled to enable communications between server machines. Each of the modules 702-714 are communicatively coupled (e.g., via appropriate interfaces) to each other and to various data sources, so as to allow information to be passed between the modules 702-514 of the search system 700 or so as to allow the modules 702-714 to share and access common data. The various modules of the search system 700 can furthermore access one or more databases 126 via the database server(s) 124.

The search system 700 can facilitate receiving search requests (e.g., queries), processing search queries, and/or providing search results page data to a client device 110. In a particular example, the search system 700 can facilitate computing price demand of an arbitrary user query by the search engine modules 706. The price demand may be measured by a CD ranking score. To this end, the search system 700 illustrated in FIG. 7 includes the application interface module(s) 702, the DSBE module(s) 704, the search engine module(s) 706, the data access module(s) 710, and the web-front module(s) 712.

The application interface module(s) 702 can be a hardware-implemented module which can be configured to communicate data with client devices. From the perspective of the search system 700, client devices can include user devices, such as the client device 110 of FIG. 1, and/or the third party server(s) 130 of FIG. 1. In operation, the application interface module(s) 702 can receive request messages corresponding to search requests, for example.

The search engine module(s) 706 can be a hardware-implemented module which can facilitate searching. The search engine modules 706 provide the functionality to process the search queries received. The processing of the search queries may involve the search servers 235 and the query node servers 232 as shown in FIG. 2 and FIG. 4. In an example embodiment, the search engine modules(s) 706 can generate search results data by processing a search query in response to receiving a request from a client device via the application interface module(s) 702. In an alternative embodiment, the search engine module(s) 706 interfaces with a third-party application, such as a third-party applications 132, via the application interface module(s) 702. The item searching modules 708 may receive a query as input (via the application interface module 702) and produce a set of items matching the query using an index that maps words to documents, as shown in FIG. 6. The item ranking modules 710 compute a ranking score for the items returned from the query which is used to rank the items returned by the item searching modules 708 from the query.

In various embodiments, machine learning modules 714 are used to compute the ranked search results for a query. The machine learning modules are trained offline using various sample data. Various inputs into one or more of the machine learning modules 714 include price demand. The machine learning modules 714 represent a number machine learning algorithms, each trained to compute a different machine learned ranking (MLR) scores. The MLR scores generated by the machine learning modules 714 are used to compute the ranking score for the search results.

The data access modules) 710 can be a hardware-implemented module which can provide data storage and/or access. Search results data can be stored in or retrieved from the database 126 via the data access module(s) 710.

For example, the data access module(s) 710 can access the search results data. As used herein, the operation of accessing includes receiving the search results data from the search engine directly and can also include accessing a data memory device storing the search results data. As such, the data access module(s) 710 can interface with the database 126 of FIG. 1.

Additionally, the data access module(s) 710 may be used to retrieve information requested by the offline system 240. For example, the offline system 240 retrieves log information 227 (via the data access module(s) 710) from the databases 126 to compute the dictionary information 225. As such, the data access module(s) 710 can interface with the offline system 240 shown in FIG. 2.

The web-front module(s) 712 can be a hardware-implemented module which can provide data for displaying web resources on client devices. For example, the search system 700 can provide a webpage for displaying the search results data.

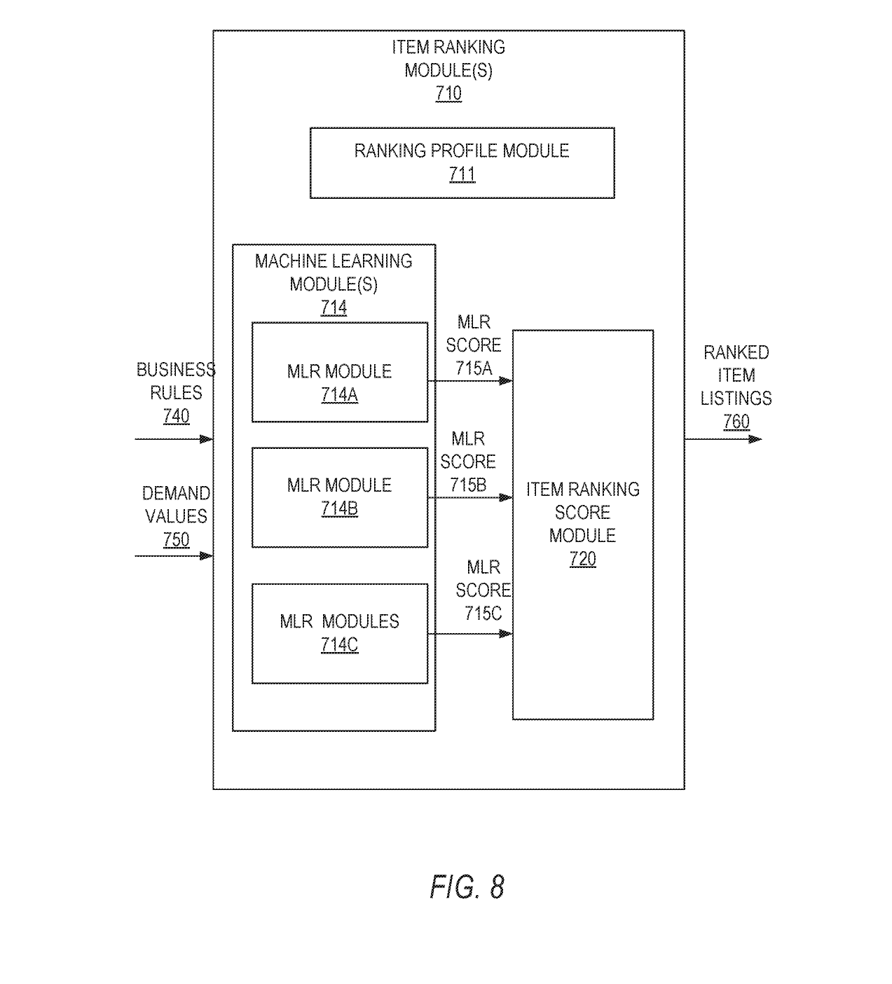

FIG. 8 illustrates the item rankings modules 710, which includes the machine learning modules 714, in further detail. FIG. 8 illustrates an example of the item ranking modules 710. The item ranking module 710 includes a ranking profile module 711 for a site. The profile is used to identify the information used by the item ranking modules 710, in particular, the inputs (e.g., demand values 750) into the machine learning modules 714 and the business rules 740 used to compute ranking score for producing the ranked item listings 760, or ranked search results. Examples of the demand values 750 provided as input to the item ranking modules 710 include the price demand score. The ranking value of an item can be referred to as a score or a ranking position. The score can be based on a number of characteristics, such as, but not limited to relevancy score, popularity, seller rating, seller history data, price, listing date, listing end date, discounts, and/or a combination of one or more of the like characteristics.

The machine learning modules 714 shows examples of machine learning ranking (MLR) modules. The MLR module 714A produces the MLR score 715A, the MLR module 714B produces the MLR score 715B, and the MLR modules 714C produces the MLR score 715C. The MLR scores 715A-C are received as inputs into the item ranking score module 720 that generates the ranking score for the matched items. The item ranking modules 710 produces the ranked item listings 760, which represents the search results in a ranked order.

In an example embodiment, the search results data can correspond to a list of items. Additionally, the search results data can further correspond to ranking data that is suitable for ranking the items. For example, the search results data can include a ranking score for each of the items of the search results. Additionally or alternatively, the items of the search results can be provided in an order that is indicative of their rankings, for example, ordered from most relevant to least relevant or ordered from least relevant to most relevant. Accordingly, an example embodiment can provide an ordered search results list and can thus omit explicit ranking value data.

FIGS. 9A-9C are interface diagrams illustrating example user interfaces 900A-900C delivered to a client device by a search system. The user interfaces 900A-900C includes a frame 902 for providing a user interface to receive search query input from a user and displaying the resulting search result page data. The frame 901 includes elements 904-912. The element 904 can correspond to a user selectable control element for navigating to the previous display of the user interfaces 900A-900C. The element 906 can correspond to text data from the user. The text data can specify one or more search terms, such as “TERM 1,” “TERM 2,” “TERM 3,” . . . , “TERM N.” FIG. 9A shows the search query “lego,” FIG. 9B shows the search term “lego star wars,” and FIG. 9C shows the search term “lego star wars 75105.” The element 908 can correspond to a user selectable control element, such as a button, for initiating a search query using the user input provided to the element 906. The element 910 can correspond to a display element for displaying search results page data in response to a selection of the element 908 for submitting a search query. In FIGS. 9A-9C, the search results for the queries submitted by the user are displayed showing a listing of items, and for each item a description and price is also shown.

FIG. 9A displays search results for the query “lego” shown in element 906. The highlighted items (ITEM 1-ITEM 6) represent item listings that have been viewed on by the user to generate view events for ITEM 1-ITEM 6.

FIG. 9B displays search results for the query “lego star wars” shown in the element 906. The highlighted items (ITEM 1 and ITEM 5-ITEM 9) represent item listings that have been viewed by the user to generate view events for ITEM 1 and ITEM 5-ITEM 9.

FIG. 9C displays search results for the query “lego star wars 75105” shown in the element 906. The highlighted items ITEM 9-ITEM 13 represent item listings that have been viewed by the user to generate view events for ITEM 9-ITEM 13.

The three queries shown in FIGS. 9A-9C represent queries for a user session. A session can be initiated when a user logs into a site, or is recognized by the site as returning user who is associated with activity on the site. For example, a site may recognize a returning user via cookies. A session can be considered terminated after a user logs off of a site or becomes inactive (or idle) on the site for a predetermined period of time. For example, after 30 minutes of idle time without user input (i.e., not receiving any queries or clicks), the system may automatically end a session. Other ways of initiating and ending a session may also be used to define a session for a user in example embodiments.

FIG. 9D illustrates a session table 960 summarizing the user events recorded (i.e., recorded view events and recorded buy events) for the three queries shown in FIGS. 9A-9C. During the session shown in the session table 960, Q1 is the first query submitted by the user and after viewing six items (that generates six view events for the session) for the search results of Q1, the user submits as second query Q2. The user then views six items (that generate six additional view events for the session) from the search results of Q2 and subsequently submits a third query Q3. The user views eight items (that generate eight more view events for the session) and purchases two items (that generate two buy events for the session) from the search results for Q3.

In various embodiments, the latter queries contribute to earlier queries if a latter query contains the search string of a former query. The search string in the latter query may be separated by additional search terms in example embodiments. In this situation, the latter query is considered to be a more specific query of the earlier query, to some extent. Such a contribution may be considered reasonable when two queries from a session have some “general-specific” relationship. The contribution from the latter query to the earlier query (when a general-specific relationship exists) can include combining the set of user events from the latter query with the set of user events with the former query. The set of events associated with the former query increases as user events from latter queries are added or contributed to it. This session-based contributions from former queries may increase the relevant data used to compute price demand for the former query by adding additional price points. As more price point are associated with a query, the price distribution (representing buyer demand by price range), provides more insight as to what buyers are likely to purchase such that a search system can present more relevant search results.

Although FIG. 9D describes view events and price events, other user events may be used, such as impressions (i.e., item listings shown from the search results). Other examples, may include a single user event (e.g. only view events) or a combination of multiple user events.

The table 960 shows the following columns; query 561, search term 1 962, search term 2 963, search term 3 964, search results (#items) 965, item 966, view event (click) 967, buy event 968, and item price 969. In addition to illustrating the clicks (shown in the column 967) by the user for each query (also referred to as view events), the table 960 for shows buy events from the session. The buy event column 968 illustrates ITEM 13 was purchased and ITEM 16 was purchased. These two items were item listings included in the search results from Q3 “lego star wars 75105.”

The session table 960 illustrates that the search query Q1 (lego) includes one search term, the search query Q2 includes two terms, and the search query Q3 includes a third search term. Each search term can include one or more words in an example embodiments. For example, a user can use quotation marks to designate more than one word as a search term, for example “Star Wars.” In this example, the search system recognizes “Star Wars” as a single search term even though it contains two words. The combination of the search terms for a query define a search string for a query. In other words, the search string includes all the search terms in a query.

In example embodiments, a query expansion algorithm may be used prior to identifying search terms in a query for the purpose of determining a general-specific relationship between queries (by comparing query strings including one or more search terms). The search string of a query may contain words that have been modified via the query expansion algorithm, to make similar variations of search terms appear to be the same search terms to the search system. For example, the query expansion algorithm can make adjustments to singular and plural variations to appear as the same search term, lower case and upper variations appear as the same search term, variations in verb forms and tenses appear as the same search term, and words having the same stem word appear as the same search term for purposes of determining a general-specific relationship between queries. In further embodiments, the query expansion algorithms may make variations (other than those described above) in search terms appear to be the same search terms.

The session table 960 shows that Q1 (lego) is a more general search query than Q2 and Q3, and Q2 (lego star wars) is a more general search query than Q3, and Q3 (lego star wars 75105) is the most specific query in the session shown in the session table 960 because it has the most search terms and is the most specific. Thus, each combination of two queries within a session has a relationship. If there is one query in the combination that is more general than another query, than that combination has a general-specific relationship. For various example embodiments, a general-specific relationship between two queries may be created when the search string of the general query is part of the search string of the specific query. For alternative embodiments, a general-specific relationship between two queries may be created by having a brand-model relationship, where the brand is considered more general relative to the model. For example, the brand represents the general relationship and the model represents the specific relationship.

For example, the combination of Q1 and Q2 forms a general-specific relationship because the search string of Q1 “lego” is part of the search string of Q2 “lego star wars.” In another example, the combination of Q2 and Q3 also forms a general-specific relationship because the search string of Q2 “lego star wars” is part of the search string of Q3 “lego star wars 75105.” For the example shown in the session table 960, the search strings includes search terms that represent adjacent words. For various embodiments, it is not necessary for the search string to include adjacent or appended words or terms. FIG. 9E illustrates another example of relationships formed between queries in a session.

According to the session table 960, view events for ITEMS 1-6 define a set of 6 view events for Q1, view events for ITEM 1 and ITEM 5-ITEM 9 define a set of 6 view events for Q2, and view events for ITEM 9-ITEM 16 define a set of 8 view events for Q3. Additionally, the buy events for ITEM 13 and ITEM 16 define a set of 2 buy events for Q3, and also represents the only buy events for the session shown in the session table 960.

In example embodiments, the following iterative process is used to determine contributions from one query to another query within a session based on a general-specific relationship. Although the iterative process is described as using view item events, other types of user events may use the same iterative process. For each session, wherever there is a view event (represented by “V”) for a query Qₙ, all the queries before that view event V are evaluated. Q1, Q2 . . . Qn. Starting with Qₙ, the system iterates over i, where i=n-1, n-2 . . . 1. The view event V will not only contribute to Qₙ, but also contribute to Q1 . . . Qn-1 if and only if the search string of Qₙ includes the whole search string of Qᵢ.

This iterative process of generating contributions based on a condition creates a large number of tuples (Qi, price, number of view events) for each query. As mentioned above, the view event may represent any number of user events (representing a user interaction associated a search results), for example, buy events, impressions, watch events, bid events, etc. If there is more than one type of user event, tuples for a first type of user event may be stored in one table and tuples for a second type of user event may be stored in another table.

For alternative embodiments, the iterations or order of comparing the queries may not be limited to starting with the latest query and iterating until the earliest query. It is possible for a former query to contribute to a latter query in some embodiments.

The contribution of a latter query to a former query within a session is based on the condition of a general-specific relationship between the former and latter queries in a session, where the former query is defined to be general with respect to the latter query as defined by their search strings. For various embodiments, the search string may include search terms which are not adjacent or appended. FIG. 9E illustrates an example where the search string of the former query are included within the search string of the latter query even if the search terms in the search string of the former query does not represent adjacent search terms.

For example, if Qi=“nike” and Qn=“nike t-shirt,” then the price of the item associated with the view event V will not only contribute to the price demand computation of Qn (nike t-shirt) but also to the price demand computation of Qi (nike). But if Qi=“nike basketball” and Qn=“nike t-shirt”, then Qn will not contribute to the price demand computation of Qi.

The general-specific relationships between queries in a session is based on the search terms used in the queries. Although the example described in the session table 960 is based on a general-specific relationship where the search string of the former query is included in the search string of the latter query, other general-specific relationship may be used. The general-specific relationship may be based on a brand-model relationship, or some other general-specific relationship.

FIG. 9E illustrates a table 900E showing the relationships of queries from a session, in accordance with an example embodiment. The table 900E includes a column 970 labeled specific, a column 971 labeled general, and a column 972 labeled contribute. For the example shown in FIG. 9E, there are four queries in this session: Query 1 “lego,” Query 2 “logo yoda;” Query 3 “logo star wars yoda;” and Query 4 “star wars lego.” The table 900E shows general-specific relationships between Query 1-Query 4, Query 1-Query 3, Query 1-Query 2, and Query 2-Query 3. The general-specific relationship shown in this example is based on having the search string of the former query, which is a more general query, included within the search string of the latter, which is a more specific query.

The Query 1 is the first query submitted in the session, Query 2 is the second query submitted in the session, Query 3 is the third query submitted in the session, and Query 4 is the last query submitted in the session. The Query 1 “lego” is the most general query and has its search string included within the search strings of Query 2, Query 3, and Query 4. Additionally, Query 2 “lego yoda” has its search string included within the search string of Query 3 “lego star wars yoda.” in this example, although the search string “lego yoda” from Query 2 do not represent adjacent search terms in the search string “lego star wars yoda,” Query 3 still contributes to Query 2. In example embodiments, the search string of the former query is considered included within the search string of the latter query, even if search terms from the search query of the latter query is separated by one or more search terms in the latter query.

Additionally, in the example shown in table 900E, only latter queries contribute to former queries. Accordingly, although all search terms in Query 4 (latter query) are included in Query 3 (former query), Query 3 does not contribute to Query 4.

The iterative process describe above determines contributions between queries for a session, where pairs of queries (e.g., defined as former-latter queries) have general-specific relationships. From the historical query data, each of the queries is associated with a set of user events that were recorded by the search system. The set of user events that were recorded are updated with user events from other queries based on a defined relationship. This iterative process is performed for each session included within the historical query data. Thus, the set of user events may be referred to as session-based sets of user events. As the iterative process determines that other queries contribute to the session-based set of user events of a particular query, the session-based set of user events for that particular query is updated.

In this example, the defined relationship is a general-specific relationship with the general query being a former query and the specific query being a latter query. The general-specific relationship is also based on the search terms within the search string of the queries. In this example, the contribution of one query to another query is based on an example condition that if a latter query contains a search string of a former query, then user events associated with the latter query are added to a session-based set of user events for the former query to contribute to an updated session-based set of user events for the former query.

The iterative process starts with Query 4 (e.g., Qₙ which is the latest query. In this example n=4. The process evaluates whether Query 4 contributes to Query 3 based on the example condition. Query 4 does not contribute to Query 3. In this example Query 4 does not contribute to Query 3 because Query 3 is a more specific query than Query 4 and this example condition is not satisfied.

The iterative process continues and evaluates whether Query 4 contributes to Query 2. Query 4 does not contribute to Query 2 because the example condition is not satisfied. More specifically, the search term “yoda” from Query 2 is not included in the search string of Query 4.

Then, the iterative process evaluates whether Query 4 contributes to Query 1. The search string “lego” from Query 1 is included within the search string “star wars ego” from Query 4. Thus, the iterative process determines that Query 4 contributes to Query 1. Next, the session-based set of user events associated with Query 1 are updated by adding the session-based set of user events associated with Query 4 to it. At this point, the updated session-based set of user events associated with Query 1 is updated by adding the session-based set of user events associated with Query 4 to it. At this point, the iterative process has evaluated Query 4 with respect to all prior queries in the session (e.g., Q3, Q2, and Q1).

Next, the iterative process moves onto Query 3 (e.g., Qₙ₋₁) and compares Query 3 with all prior queries in the session. Query 3 is evaluated to determine whether Query 3 contributes to Query 2. A determination is made that Query 3 contributes to Query 2. The session-based set of user events associated with Query 2 is updated by adding the session-based set of user events associated with Query 3 to it.

Next, Query 3 is evaluated to determine whether Query 3 contributes to Query 1. A determination is made that Q3 contributes to Q1. The session-based set of user events associated with Query 1 are updated by adding the session-based set of user events associated with Query 3 to it. At this point, the session-based set of user events associated with Query 1 has been updated with both the session-based sets of user events associated with Query 4 and Query 3.

Finally, the iterative process evaluates whether Query 2 (e.g., Qₙ₋₂) contributes to Query 1 (where Qₙ=1). A determination is made that the example condition is satisfied and Query 2 contributes to Query 1. The session-based set of user events associated with Query 1 are updated by adding the session-based set of user events associated with Query 2 to it. At this point, the session-based set of user events associated with Query 1 has been updated with the session-based sets of user events associated with Query 4, Query 3, and Query 2.

Once the iterative process for a session is completed, then each query is associated with a final updated session-based set of user events. In this example, the final updated session-based set of user events for Query 1 includes the session-based sets of user events associated with Query 4, Query 3, Query 2, and Query 1. The final updated session-based set of user events for Query 2 includes the session-based sets of user events associated with Query 3 and Query 2. The final updated session-based set of user events for Query 3 includes the session-based sets of user events associated with Query 3. The final updated session-based set of user events for Query 4 includes the session-based set of user events associated with Query 4. Neither Query 3 nor Query 4 have any contributions from other queries within the session from the iterative process. Thus, the session-based set of user events associated with Query 3 (e.g., recorded users events), the updated session-based set of user events associated with Query 3 and the final updated user events associated with Query 3 all represent the same set of user events. Similarly, the session-based set of user events associated with Query 4 (e.g., recorded users events), the updated session-based set of user events associated with Query 4 and the final updated user events associated with Query 4 all represent the same set of user events.

The user events define what prices to use in the price demand computation. Although the example shown in FIGS. 9A-9E uses view events and buy events to define the pricing used to compute price demand, other types of user events may be used to define the pricing in alternative embodiments. A user event and its associated price may be referred to as a user event-price pair. If the user event is a view event, the pair may be referred to as a view event-price pair. If the user event is a buy event, the pair may be referred to as buy event-price pair.

FIGS. 9A-9E illustrate an example of a single user session and how user events from latter queries may contribute to former queries if a specific condition is met. The contributions from the latter queries increases the relevant data, by adding additional price points, used to compute price demand for the former query. In various embodiments, the tuples (Qi, price, number of user events) for a single user session-based data may be aggregated for multiple sessions for each query. In such embodiments, the price points for a query are derived from many single user sessions which include the query.

According to various embodiments, the user events (and associated prices) are aggregated twice. The first type of aggregation is referred to as user event aggregation by contribution (or contribution aggregation per session) and is based on contributions of latter queries if a specific condition is met for queries within a session. An example of the user event aggregation by contribution is described in FIGS. 9A-9E. The aggregation by contribution for a single session produces session-based sets. The sets may refer to sets of user event, sets of prices, and sets of user event-price pairs. Thus, the aggregation by contribution produces session-based sets of user events, session-based sets of prices, and session-based sets of user-event pairs. As described above, the iterative process of determining which queries contributes to another query within a session may update the session-based set of user events, the session-based sets of prices, and the session-based sets of user-event pairs during the iterations.

The second type of aggregation, which occurs after the user event aggregation by contribution for a single session, is referred to as user event aggregation over sessions (or multiple session aggregation). An example of the second type of user event aggregation is described in FIGS. 10A-10E. The user event aggregation of queries from multiple session produces multiple session sets. The multiple session sets may refer to sets of user event, sets of prices, and sets of user event-price pairs. Thus, the user event aggregation of multiple sessions produces multiple session sets of user events, multiple session sets of prices, and multiple session-sets of user-event pairs.

FIGS. 10A-10E illustrate an example of multiple session user event aggregation of a number of queries. For this example, the contribution by user event aggregation per session has already be completed as shown in FIG. 10A.

A table 1000A shown in FIG. 10A illustrates four sessions: session 1, session 2, session 3, and session 4. Each of the sessions includes multiple queries. The queries used in this example include query 1 (Q1) “Nike,” query 2 (Q2) “Nike T-Shirt,” query 3 (Q3) “Nike T-Shirt Red,” and query 4 (Q4) “Nike Basketball.” The queries Q1, Q2, Q3, and Q4 are shown along the top of the table 1000A (i.e., column headers). The sessions: session 1, session 2, session 3, and session 4 are shown down the left side of the table 1000A (i.e. row headers)

The table 1000A shows that session 1 includes Q1, Q2, Q3, and Q4; session 2 includes Q1 and Q4; session 3 includes Q1, Q2, and Q4; and session 4 includes Q1, Q2, and Q3. Each data cell shown in the table describes the session-based contributions for each of the queries from each session and the final updated session-based set of user events. The data shown in the data cells also represent the results of the first type of aggregation described above (i.e., user event aggregation by contribution (or contribution aggregation per session) and is based on contributions of latter queries if a specific condition is met for queries within a session). The final updated session-based sets of user events may be described by the nomenclature Query number:Session number User Event Set. For example, for Query 1 and Session the nomenclature Query 1:Session1 User Event Set may be used.

The multiple sessions represents sessions from many different users, and the same user can be associated with more than one session. The tables 1000B-1000E includes the following columns: session 1001, final updated session based. set of user events for a query 1002; and user event aggregation of a query across multiple sessions1003.

A table 1000B shown in FIG. 10B represents data for Q1 “Nike.” The user event aggregation of Q1 across multiple session is shown to be the aggregated set of data including: Q1:Session 1 User Event Set, Q1:Session 2 User Event Set, Q1: Session 3 User Event Set, and Q1: Session 4 User Event Set. This aggregated set of data for Q1 produces a set of price points that is used for computing price demand. Each price point corresponds to an item associated with a user event from the aggregated set for Q1.

A table 1000C shown in FIG. 10C represents data for Q2 “Nike T-Shirt.” The user event aggregation of Q2 across multiple session is shown to be the aggregated set of data including: Q2:Session 1 User Event Set and Q2: Session 4 User Event Set. This aggregated set of data for Q2 produces a set of price points that is used for computing price demand. Each price point corresponds to an item associated with a user event from the aggregated set for Q2.

A table 1000D shown in FIG. 10D) represents data for Q3 “Nike T-Shirt Red.” The user event aggregation of Q3 across multiple session is shown to be the aggregated set of data including: Q3:Session1 User Event Set Q3:Session 2 User Event Set, and Q3: Session 4 User Event Set. This aggregated set of data for Q3 produces a set of price points that is used for computing price demand. Each price point corresponds to an item associated with a user event from the aggregated set for Q3.

A table 1000E shown in FIG. 10E represents data for Q4 “Nike Basketball.” The user event aggregation of Q4 across multiple session is shown to be the aggregated set of data including: Q4:Session1 User Event Set, Q4: Session 2 User Event Set, and Q4: Session 3 User Event Set. This aggregated set of data for Q4 produces a set of price points that is used for computing price demand. Each price point corresponds to an item associated with a user event from the aggregated set for Q4.

The tables 1000B-1000E are used to shown the second type of aggregation described above. The second type of aggregation represents the user event aggregation of queries from multiple session and produces multiple session sets. The multiple session sets may refer to sets of user event, sets of prices, and sets of user event-price pairs. This aggregated set of data for each query produces a set of price points that is used for computing price demand. Each price point used to compute price demand for a query corresponds to an item from the aggregated set for that query.

Although the tables 1000B-1000E illustrate creating sessions for a user event, that user event may represent many different types of user interactions (e.g., view events, buy events, watch events, and bid events). In the event that more than one type of user interaction is used to compute price demand for a query, the first type and the second type of user aggregations described above, may be performed for each type of user event.

For various embodiments, two types of user events are used to define price points to compute the demand score. For example, a first type of user event is a view event, and a second type of user event is a buy event. In example embodiments, weighting for the two types of user events is computed. For embodiments that use view events and buy events, the following linear formula may be used:

weight of (query, price)=w*(number of sold items*price)+(1−w)* view count

where,

w=1−2̂(−n/H);

n is the number of all sale counts for that query; and

H is a constant.

The smaller the value of H, the more weight is given to the sale part (i.e., buy events and number of sold items). An example value of the constant H is 1000.

Once the price points and corresponding weights are computed, the final price distribution of each query may be calculated by using the (price, weight) as inputs into a density function, for example embodiments. FIG. 10F illustrates an example of price demand table generated by a density function. The price demand table for a query shows price ranges corresponding to price demand values. FIG. 11 illustrates price demand chart corresponding to the price demand table 1000F. The price demand chart displays the price ranges along the x-axis and the price demand values (by percentage) on the y-axis. By evaluating the price demand chart 1100, one can visually see that the price range $62.34; $128.43 represents the highest price demand at 39%.

Once the price demand values are calculated for a query, this information is stored in price demand table. In an example embodiment, the price demand table may include columns for site, query, minimum price, maximum price and demand value. The price demand table may be implemented in the dictionary 225A (FIG. 3) in example embodiments.

In example embodiments, the price demand tables may be computed offline (e.g., the offline system 240 shown in FIG. 2), and then copied into a database and stored as the dictionary information (e.g., dictionary information 225 shown in FIG. 2). The dictionary information is accessible to a search system during runtime (e.g., runtime system 230 shown in FIG. 2).

For example, a user submits a search query “Nike T-Shirt Red” via a user interface of an e-commerce site. In response to the user's search query, the search engine of the e-commerce site then searches for items and returns items matching the user's search query. The search engine also provides functionality to rank the matching items returned. In example embodiments, the session-based price demand provides input into one or more search ranking algorithms to compute a ranking score for the matching items, which is used to rank the search results which are displayed to the user. Although the algorithms that ranks items depends on many factors, price demand, which indicates demand from buyers, price demand is an important factor used by the ranking algorithms.

The various embodiments of computing session-based price demand described in this disclosure improves search ranking in e-commerce sites. Although the examples described illustrate how the session-based price demand may be used to rank items for returning search results on an-commerce site, the session-based price demand may be used by a listing system of an e-commerce site to make recommendations to sellers who are listing items on the e-commerce site. For example, the session-based price demand may be used or provide suggestions of what price range a seller may want to list items on the e-commerce site. Additionally, it should be noted that the various embodiments described are not limited to e-commerce site and may be used to improve search ranking in other types of online systems that allows users to enter search queries. The various embodiments describing the session-based price demand may be used by other types of online search systems.

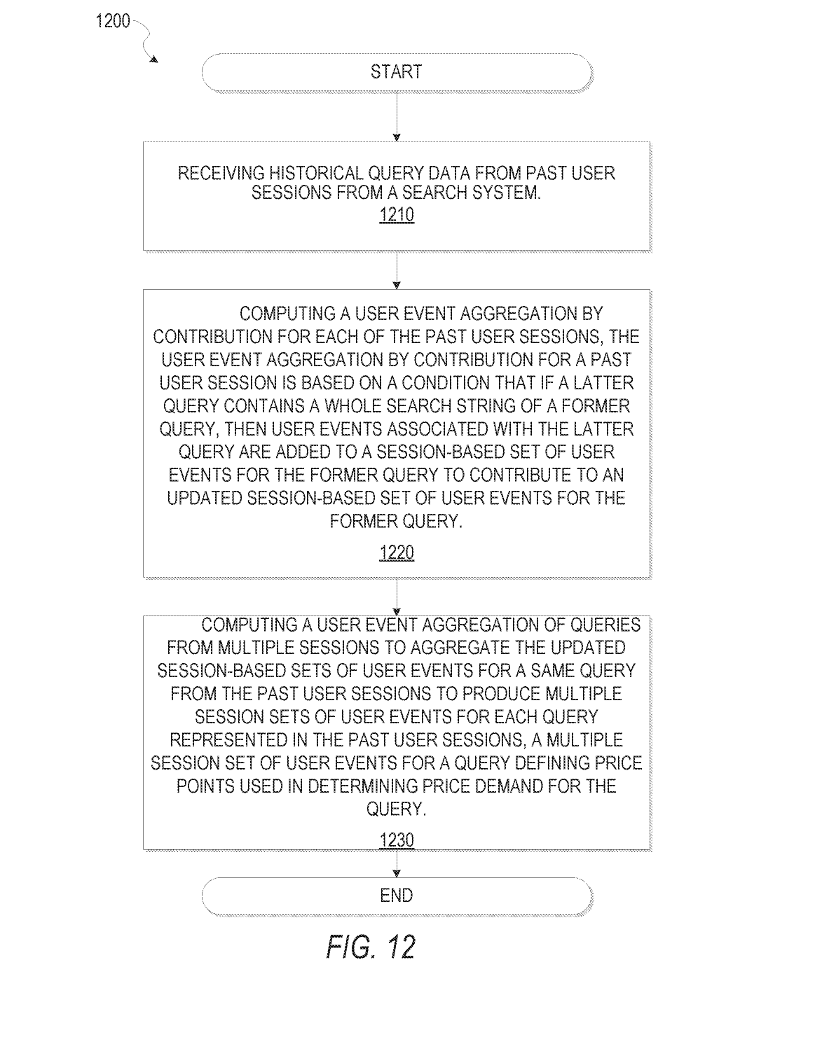

FIGS. 12-14 illustrate flow diagrams describing example methods for computing price demand for a query. The example methods 1200-1400 will be described below, by way of explanation, as being performed by certain modules, components or systems. It will be appreciated, however, that the operation of the example methods can be performed by any suitable order by any number of modules, components or system shown in FIGS. 1-5, 7, and 8.

FIG. 12 is a flow diagram 1200 illustrating an example method of generating price points for computing price demand for a query. The method show in FIG. 12 includes operations 1210-1230. At operation 1210, historical query data for past user sessions from a search system is received. Each of the past user sessions represents at least one query. The historical query data includes user events associated with queries in each of the past user sessions.

At operation 1220, a user event aggregation by contribution for each of the past user sessions is computed. The user event aggregation by contribution for a past user session is based on a condition that if a latter query contains a whole search string of a former query, then user events associated with the latter query are added to a session-based set of user events for the former query to contribute to an updated session-based set of user events for the former query. In various embodiments, the condition is applied iteratively to each combination of two queries having a latter-former relationship from each of the past user sessions starting with the last query in each of the past user sessions and ending with the first query in each of the past user sessions. In various embodiments, the user event aggregation by contribution is determined to be complete prior to performing the aggregation of queries from multiple sessions.

At operation 1230, a user event aggregation of queries from multiple sessions to aggregate the updated session-based sets of user events for a same query from the past user sessions is computed. This aggregation produces a multiple session set of user events for each query represented in the past user sessions. The multiple session set of user events for a query is used to define price points used to generate price demand for the query.

In various embodiments, a search system receives historical query data for past user sessions from a search system. Each of the past user sessions represents at least one query. The historical query data includes user events associated with queries in each of the past user sessions. A user event aggregation by contribution for each of the past user sessions is computed. The aggregation by contribution for a past user session is based on a condition related to general-specific relationships between former queries and a latter queries in the past user session such that latter queries contribute to former queries if the condition is satisfied to produce updated session-based sets of user events for the former queries. A user event aggregation of queries across multiple sessions is computed to aggregate the updated session-based sets of user events for a same query from the past user sessions to produce multiple session sets of user events for each query represented in the past user sessions. A multiple session set of user events for a query defines price points used in determining price demand for the query.

In example embodiments, the price demand is generated for each of the queries using the price points for each of the queries. In further embodiments, the the price demand is stored in a table which is accessible to the search system when the search system receives a query. In further embodiments, the user events represent user events of a first type and user events of a second type. For example, the user events of the first type may represent view events and the user events of the second type may represent buy events.

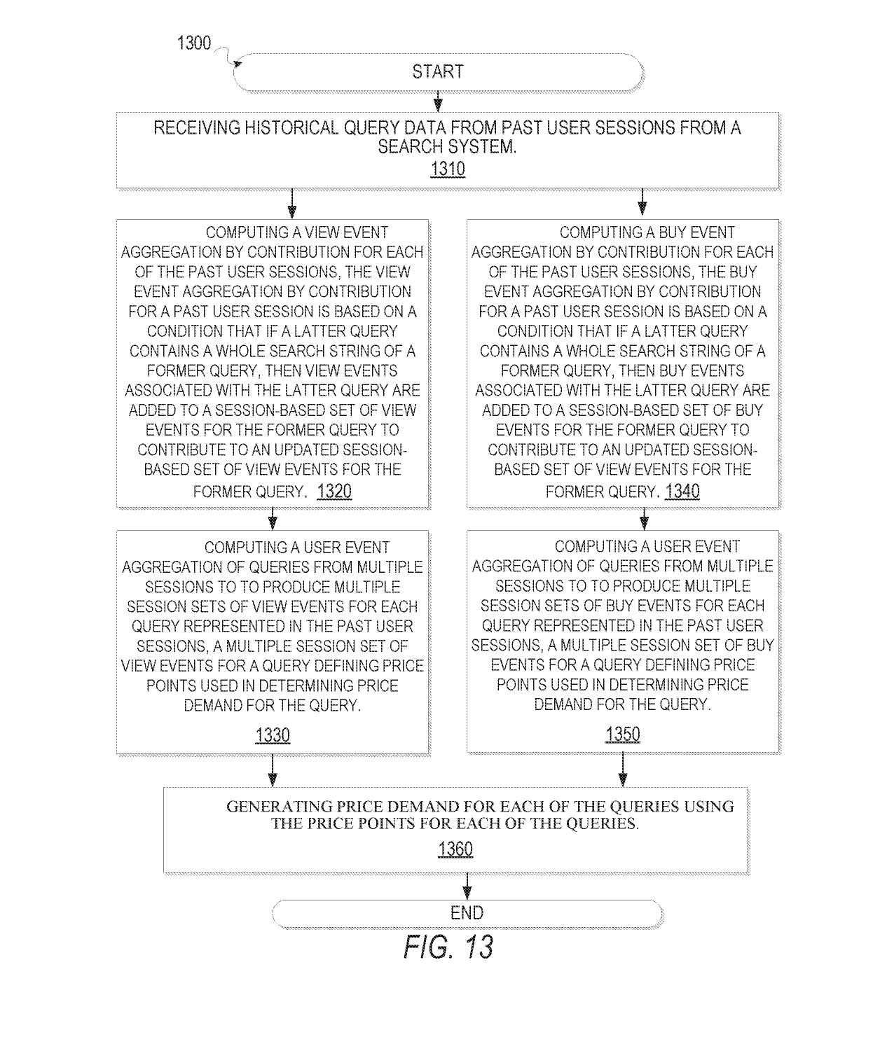

FIG. 13 is a flow diagram 1300 illustrating an example method of generating price demand for a query based on view events and buy events. The method shown in FIG. 13 includes operations 1310-1360. At operation 1310, historical query data for past user sessions from a search system is received. Each of the past user sessions represents at least one query. The historical query data includes user events associated with queries in each of the past user sessions. The user events include view events and buy events. The operations 1320 and 1330 relate to the view events and the operations 1340 and 1350 relate to the buy events. In other example methods, the view event and/or buy event may be replaced with other types of user events.

At operation 1320, a view event aggregation by contribution for each of the past user sessions is computed using the view events. The view event aggregation by contribution for a past user session is based on a condition that if a latter query contains a whole search string of a former query, then view events associated with the latter query are added to a session-based set of view events for the former query to contribute to an updated session-based set of view events for the former query. In various embodiments, the condition is applied iteratively to each combination of two queries having a latter-former relationship from each of the past user sessions starting with the last query in each of the past user sessions and ending with the first query in each of the past user sessions. In various embodiments, the view event aggregation by contribution is determined to be complete prior to performing the aggregation of queries from multiple sessions.

At operation 1330, a view event aggregation of queries from multiple sessions to aggregate the updated session-based sets of view events for a same query from the past user sessions is computed. This aggregation produces a multiple session set of view events for each query represented in the past user sessions. The multiple session set of view events for a query is used to define price points used to generate price demand for the query.

At operation 1340, a buy event aggregation by contribution for each of the past user sessions is computed using the buy events. The buy event aggregation by contribution for a past user session is based on a condition that if a latter query contains a whole search string of a former query, then buy events associated with the latter query are added to a session-based set of buy events for the former query to contribute to an updated session-based set of buy events for the former query. In various embodiments, the condition is applied iteratively to each combination of two queries having a latter-former relationship from each of the past user sessions starting with the last query in each of the past user sessions and ending with the first query in each of the past user sessions. In various embodiments, the buy event aggregation by contribution is determined to be complete prior to performing the aggregation of queries from multiple sessions.

At operation 1350, a buy event aggregation of queries from multiple sessions to aggregate the updated session-based sets of buy events for a same query from the past user sessions is computed. This aggregation produces a multiple session set of buy events for each query represented in the past user sessions. The multiple session set of buy events for a query is used to define price points used to generate price demand for the query.

At operation 1360, price demand is generated for each of the queries using the price points for each of the queries. In various embodiments, the multiple session sets of view events and the multiple session sets of buy events are combined using a linear combination function to generate weights corresponding to the price points. In further embodiments, a density function is to compute the price distribution for the price demand.

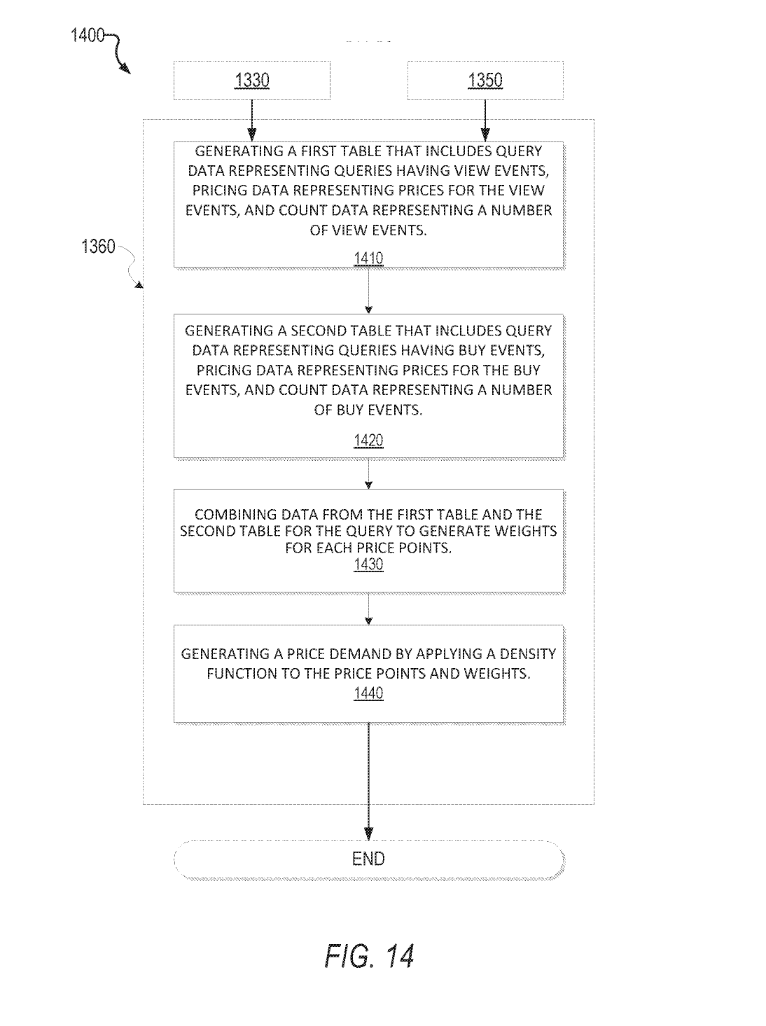

FIG. 14 is a flow diagram 1400 illustrating an example method of performing operation 1360 in further detail. The method shown in FIG. 14 includes operations 1410-1430. At operation 1410, a first table is generated. The first table includes query data representing queries having view events, pricing data representing prices for the view events, and count data representing a number of view events. At operation 1410, a second table is generated. The second table includes query data representing queries having buy events, pricing data representing prices for the buy events, and count data representing a number of buy events. At operation 1430, data from the first table and data from the second table are combined to generate weights for each price point. At operation 1440, the price demand is generated by applying a density function to the price points and weights.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5, 7, 2 and 10-14 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

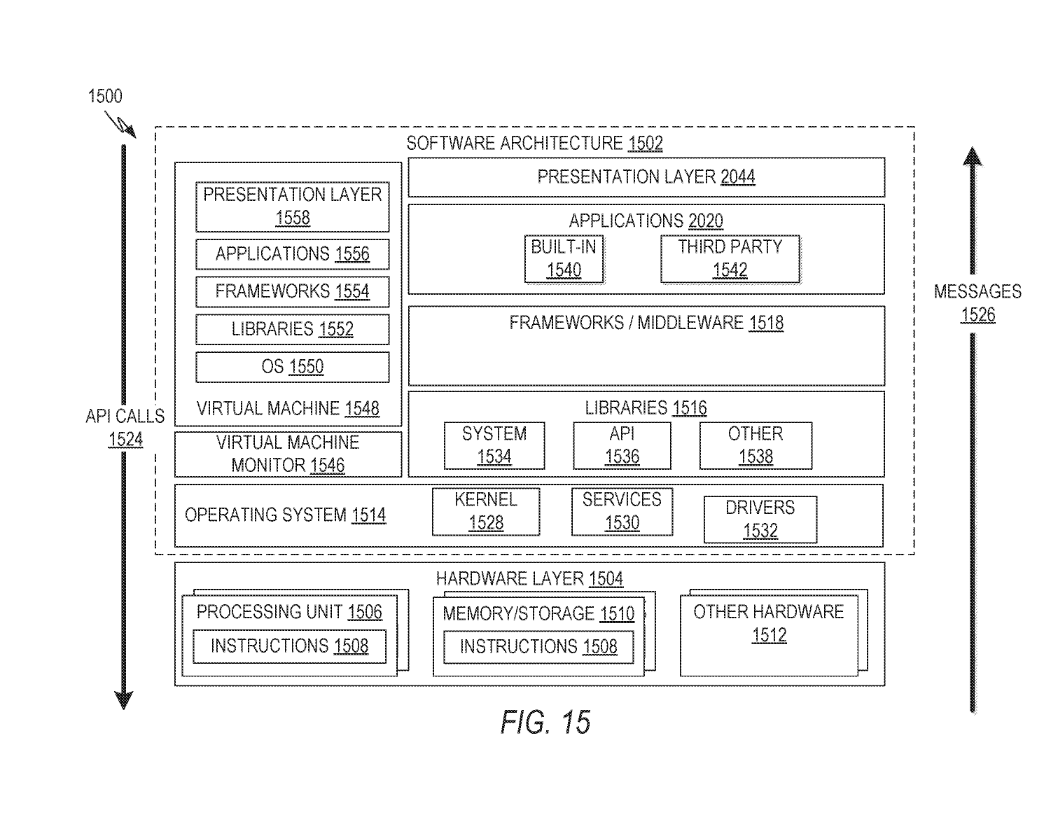

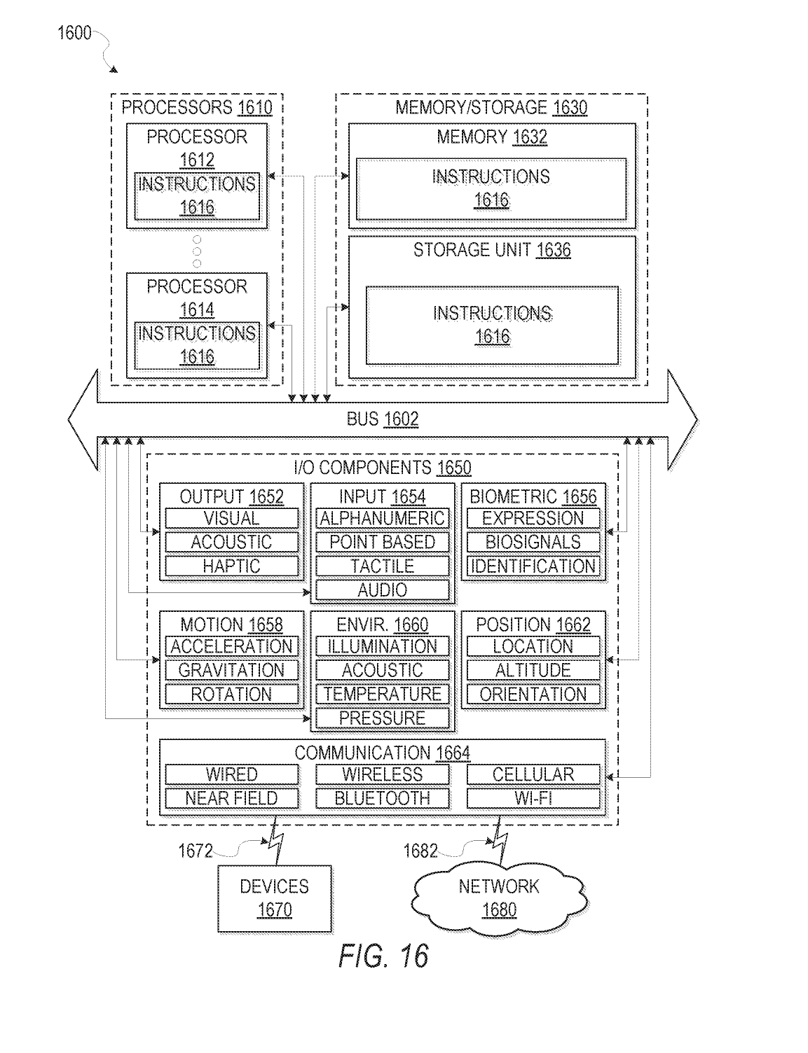

FIG. 15- is a block diagram 1500 illustrating a representative software architecture 1502, which may be used in conjunction with various hardware architectures herein described. FIG. 15 is merely a non-limiting example of a software architecture and it will be appreciated that many other architectures may be implemented to facilitate the functionality described herein. The software architecture 1502 may be executing on hardware such as machine 1600 of FIG. 16 that includes, among other things, processors 1610, memory 1630, and I/O components 1650. A representative hardware layer 1504 is illustrated and can represent, for example, the machine 1600 of FIG. 16. The representative hardware layer 1504 comprises one or more processing units 1506 having associated executable instructions 1508. Executable instructions 1508 represent the executable instructions of the software architecture 1502, including implementation of the methods, modules and so forth of FIGS. FIGS. 1-5, 7, 2 and 10-14. Hardware layer 1504 also includes memory and/or storage modules 1510, which also have executable instructions 1508. Hardware layer 1504 may also comprise other hardware as indicated by 1512 which represents any other hardware of the hardware layer 1504, such as the other hardware illustrated as part of machine 1600.

In the example architecture of FIG. 15, the software 1502 may be conceptualized as a stack of layers where each layer provides particular functionality. For example, the software 1502 may include layers such as an operating system 1514, libraries 1516, frameworks/middleware 1518, applications 1520 and presentation layer 1522. Operationally, the applications 1520 and/or other components within the layers may invoke application programming interface (API) calls 1524 through the software stack and receive a response, returned values, and so forth illustrated as messages 1526 in response to the API calls 1524. The layers illustrated are representative in nature and not all software architectures have all layers. For example, some mobile or special purpose operating systems may not provide a frameworks/middleware layer 1518, while others may provide such a layer. Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. The drivers 1532 may be responsible for controlling or interfacing with the underlying hardware. For instance, the drivers 1532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1516 may provide a common infrastructure that may be utilized by the applications 1520 and/or other components and/or layers. The libraries 1516 typically provide functionality that allows other software modules to perform tasks in an easier fashion than to interface directly with the underlying operating system 1514 functionality (e.g., kernel 1528, services 1530 and/or drivers 1532). The libraries 1516 may include system 1534 libraries (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The frameworks 1518 (also sometimes referred to as middleware) may provide a higher-level common infrastructure that may be utilized by the applications 1520 and/or other software components/modules. For example, the frameworks 1518 may provide various graphic user interface (GUI) functions, high-level resource management, high-level location services, and so forth. The frameworks 1518 may provide a broad spectrum of other APIs that may be utilized by the applications 1520 and/or other software components/modules, some of which may be specific to a particular operating system or platform.

The applications 1520 includes built-in applications 1540 and/or third party applications 1542. Examples of representative built-in applications 1540 may include, but are not limited to, a contacts application, a browser application, a book reader application, a location application, a media application, a messaging application, and/or a game application. Third party applications 1542 may include any of the built in applications as well as a broad assortment of other applications. In a specific example, the third party application 1542 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1542 may invoke the API calls 1524 provided by the mobile operating system such as operating system 1514 to facilitate functionality described herein.

The applications 1520 may utilize built in operating system functions (e.g., kernel 1528, services 1530 and/or drivers 1532), libraries (e.g., system 1534, APIs 1536, and other libraries 1538), frameworks/middleware 1518 to create user interfaces to interact with users of the system. Alternatively, or additionally, in some systems interactions with a user may occur through a presentation layer, such as presentation layer 1544. In these systems, the application/module “logic” can be separated from the aspects of the application/module that interact with a user.

Some software architectures utilize virtual machines. In the example of FIG. 15, this is illustrated by virtual machine 1548. A virtual machine creates a software environment where applications/modules can execute as if they were executing on a hardware machine (such as the machine of FIG. 16, for example). A virtual machine is hosted by a host operating system (operating system 1514 in FIG. 16) and typically, although not always, has a virtual machine monitor 1546, which manages the operation of the virtual machine as well as the interface with the host operating system (i.e., operating system 1514). A software architecture executes within the virtual machine such as an operating system 1550, libraries 1552, frameworks/middleware 1554, applications 1556 and/or presentation layer 1558. These layers of software architecture executing within the virtual machine 1548 can be the same as corresponding layers previously described or may be different.

### Example Machine Architecture and Machine-Readable Medium

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1616 (e.g., software, a program, an application, an applet, an app, or other executable code) for causing the machine 1600 to perform any one or more of the methodologies discussed herein may be executed. For example the instructions may cause the machine to execute the flow diagrams of FIGS. 12-14. Additionally, or alternatively, the instructions may implement the modules shown in FIGS. 7 and 8, and so forth. The instructions transform the general, non-programmed machine into a particular machine programmed to carry out the described and illustrated functions in the manner described. In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1616, sequentially or otherwise, that specify actions to be taken by machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 may include processors 1610, memory 1630, and I/O components 1650, which may be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1612 and processor 1614 that may execute instructions 1616. The term “processor” is intended to include multi-core processor that may comprise two or more independent processors (sometimes referred to as “cores”) that may execute instructions contemporaneously. Although FIG. 16 shows multiple processors, the machine 1600 may include a single processor with a single core, a single processor with multiple cores (e.g., a multi-core process), multiple processors with a single core, multiple processors with multiples cores, or any combination thereof.

The memory/storage 1630 may include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 may also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of processors 1610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine 1600 (e.g., processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1650 may include a wide variety of components to receive input, provide output, produce output, transmit information, exchange information, capture measurements, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the 110 components 1650 may include many other components that are not shown in FIG. 16. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1650 may include biometric components 1656, motion components 1658, environmental components 1660, or position components 1662 among a wide array of other components. For example, the biometric components 1656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1658 may include acceleration sensor components (e.g., accelerometer), gravitation sensor components, rotation sensor components (e.g., gyroscope), and so forth. The environmental components 1660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1650 may include communication components 1664 operable to couple the machine 1600 to a network 1680 or devices 1670 via coupling 1682 and coupling 1672 respectively. For example, the communication components 1664 may include a network interface component or other suitable device to interface with the network 1680. In further examples, communication components 1664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1670 may be another machine or any of a wide variety of peripheral devices (e.g., a peripheral device coupled via a Universal Serial Bus (USB)).

Moreover, the communication components 1664 may detect identifiers or include components operable to detect identifiers. For example, the communication components 1664 may include Radio Frequency identification (RFD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1664, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or other type of cellular or wireless coupling. In this example, the coupling 1682 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1616 may be transmitted or received over the network 1680 using a transmission medium via a network interface device (e.g., a network interface component included in the communication components 1664) and utilizing any one of a number of well-known transfer protocols (e.g., hypertext transfer protocol (HTTP)). Similarly, the instructions 1616 may be transmitted or received using a transmission medium via the coupling 1672 (e.g., a peer-to-peer coupling) to devices 1670. The term “transmission medium” shall be taken to include any intangible medium that is capable of storing, encoding, or carrying instructions 1616 for execution by the machine 1600, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving historical query data for past user sessions from a search system, each of the past user sessions representing at least one query, the historical query data including user events associated with queries in each of the past user sessions;
computing, using a processor of a machine, user event aggregation by contribution for each of the past user sessions, the user event aggregation by contribution for a past user session is based on a condition related to general-specific relationships between former queries and a latter queries in the past user session such that latter queries contribute to former queries if the condition is satisfied to produce updated session-based sets of user events for the former queries; and
computing, using a processor of a machine, user event aggregation of queries across multiple sessions to aggregate a final updated session-based sets of user events for a same query from the past user sessions to produce multiple session sets of user events for each query represented in the past user sessions, a multiple session set of user events for a query defining price points used in determining price demand for the query.

2. The method of claim 1, further comprising:
generating price demand for each of the queries using the price points for each of the queries; and
storing the price demand in a table which is accessible to the search system when the search system receives a query.

3. The method of claim 1, wherein computing the user event aggregation by contribution for each of the past user sessions further comprising:
applying the condition iteratively to each combination of two queries having a latter-former relationship from each of the past user sessions starting with the last query in each of the past user sessions and ending with the first query in each of the past user sessions.

4. The method of claim 1, wherein the condition is defined by having a latter query contain a search string of a former query such that user events associated with the latter query are added to a session-based set of user events for the former query to contribute to the updated session-based set of user events for the former query.

5. The method of claim 1, wherein the user events represent user events of a first type and user events of a second type.

6. The method of claim 5, wherein the user events of the first type represents view events and the user events of the second type represents buy events.

7. The method of claim 5, wherein computing the user event aggregation by contribution for each of the past user sessions further comprising:
computing the user event aggregation by contribution for each of the past user sessions using user events of the first type; and
computing the user event aggregation by contribution for each of the past user sessions using user events of the second type.

8. The method of claim 7, wherein computing the user event aggregation of queries across the multiple sessions further comprising:
computing the user event aggregation of queries from multiple sessions using the user events of the first type to produce multiple session sets of user events of the first type for each query; and
computing the user event aggregation of queries from multiple sessions using the user events of the second type to produce multiple session sets of user events of the second type for each query.

9. The method of claim 8, further comprising:
combining the multiple session sets of user events of the first type and the multiple session sets of user events of the second type using a linear combination function to generate weights corresponding to the price points.

10. The method of claim 1, further comprising:
generating price demand for each of the queries based on the prices points and corresponding weights for each of the queries.

11. A system comprising:
a memory device for storing instructions; and
a processor, which, when executing the instructions, causes a search system to perform operations comprising:
receiving historical query data for past user sessions from a search system, each of the past user sessions representing at least one query, the historical query data including user events associated with queries in each of the past user sessions;
computing, using a processor of a machine, user event aggregation by contribution for each of the past user sessions, the user event aggregation by contribution for a past user session is based on a condition related to general-specific relationships between former queries and a latter queries in the past user session such that latter queries contribute to former queries if the condition is satisfied to produce updated session-based sets of user events for the former queries; and
computing, using a processor of a machine, user event aggregation of queries across multiple sessions to aggregate a final updated session-based sets of user events for a same query from the past user sessions to produce multiple session sets of user events for each query represented in the past user sessions, a multiple session set of user events for a query defining price points used in determining price demand for the query.

12. The system of claim 11, wherein the operation of computing the aggregation by contribution for each of the past user sessions further comprising:
applying the condition iteratively to each combination of two queries having a general-specific relationship from each of the past user sessions starting with the last query in each of the past user sessions and ending with the first query in each of the past user sessions.

13. The system of claim 11,
wherein the user events of the first type represents view events and the user events of the second type represents buy events;
wherein the operation of computing the user event aggregation by contribution for each of the past user sessions further comprising:
computing the user event aggregation by contribution for each of the past user sessions using user events of the first type; and
computing the user event aggregation by contribution for each of the past user sessions using user events of the second type.

14. The system of claim 13, wherein the operation of computing the user event aggregation by contribution for each of the past user sessions further comprising:
computing the aggregation of queries across the multiple sessions using the user events of the first type to produce multiple session sets of user events of the first type for each query; and
computing the aggregation of queries across the multiple sessions using the user events of the second type to produce multiple session sets of user events of the second type for each query.

15. The system of claim 14, further comprising:
combining the multiple session sets of user events of the first type and the multiple session sets of user events of the second type using a linear combination function to generate weights corresponding to the price points.

16. A non-transitory machine-readable storage medium in communication with at least one processor, the machine-readable storage medium storing instructions which, when executed by the at least one processor, performs operations comprising:
receiving historical query data for past user sessions from a search system, each of the past user sessions representing at least one query, the historical query data including user events associated with queries in each of the past user sessions;
computing a user event aggregation by contribution for each of the past user sessions, the user event aggregation by contribution for a past user session is based on a condition related to general-specific relationships between former queries and a latter queries in the past user session such that latter queries contribute to former queries if the condition is satisfied to produce updated session-based sets of user events for the former queries; and
computing a user event aggregation of queries across multiple sessions to aggregate a final updated session-based sets of user events for a same query from the past user sessions to produce multiple session sets of user events for each query represented in the past user sessions, a multiple session set of user events for a query defining price points used in determining price demand for the query.

17. The non-transitory machine-readable storage medium of claim 16, performs operations further comprising:
generating price demand for each of the queries using the price points for each of the queries; and
storing the price demand in a table which is accessible to the search system when the search system receives a query.

18. The non-transitory machine-readable storage medium of claim 16, wherein the operation of computing the aggregation by contribution for each of the past user sessions performs operations further comprising:
applying the condition iteratively to each combination of two queries having a general-specific relationship from each of the past user sessions starting with the last query in each of the past user sessions and ending with the first query in each of the past user sessions.

19. The non-transitory machine-readable storage medium of claim 16, performs operations further comprising:
determining the user event aggregation by contribution is complete for the past user sessions prior to performing the user event aggregation of queries from the multiple sessions.

20. The non-transitory machine-readable storage medium of claim 16, wherein the user events represent user events of a first type and user events of a second type.
